(19) United States
(12) Patent Application Publication
(10) Pub. No.: US 2024/0307884 A1
(43) Pub. Date: Sep. 19, 2024

(54) PIPETTE TIPS AND RACK SYSTEM FOR LIQUID HANDLING EQUIPMENT

(71) Applicant: Integra Biosciences AG, Zizers (CH)

(72) Inventors: Christoph Mauracher, Felsberg (CH); Terrence Kelly, Lowell, MA (US); Kyle R. DelloRusso, Derry, NH (US); Lukas Wielatt, Chur (CH); Noel Pasquier, Landquart (CH)

(73) Assignee: Integra Biosciences AG, Zizers (CH)

(21) Appl. No.: 18/601,382

(22) Filed: Mar. 11, 2024

Related U.S. Application Data
(60) Provisional application No. 63/490,891, filed on Mar. 17, 2023.

(51) Int. Cl. B01L 9/00

(52) U.S. Cl. CPC B01L 9/543

(57) ABSTRACT

A pipette tip rack system includes a disposable refill pack and a reusable base. After use, the disposable refill pack can be disassembled, and the components can be stacked or nested for space saving storage prior to disposal or recycling. The pipette tips in the disposable refill pack are configured to fit on a mounting shaft that includes outwardly circumferentially extending locking lobes over which the pipette tip collar is mounted. The pipette tip includes a circular cantilever sealing ring that seals laterally against the mounting shaft when the tip is fully mounted. The circular cantilever sealing ring has an annular wall surrounded by a gap. The annular wall has an inside surface that slants inward to provide a lateral interference fit with the mounting shaft. The annular wall bends radially outward towards the gap, rather than stretching, when the tip is mounted on the mounting shaft thereby reducing require insertion force. The refill pack can be made with less plastic because of the reduced cumulative insertion forces, even when loading 384 pipette tips simultaneously in an automated liquid handling system.

### CROSS-REFERENCE TO RELATED APPLICATION

The present application claims priority of U.S. Provisional Patent Application No. 63/490,891, filed Mar. 17, 2023, the content of which is incorporated herein by reference in its entirety.

### FIELD OF THE INVENTION

The invention relates to pipette tips and racks, and more particularly to environmentally friendly, disposable tip containers which when used with a reusable, structural base is capable of loading arrays of pipette tips onto a matrix of fittings or mounting shafts on robotic (e.g. automated or semi-automated) liquid handling equipment. The invention relates in part to a configuration of disposable pipette tips and mounting shafts that provides robust sealing engagement with low insertion and ejection forces while maintaining mounted pipette tips secure and stable on the respective mounting shaft during use. The low insertion forces enable rack components to be constructed with significantly less plastic.

### BACKGROUND OF THE INVENTION

The use of disposable pipette tips with automated or semi-automated robotic liquid handling systems is well known. Disposable pipette tips enable repeated use of pipetting systems to transfer liquid reagents or liquid samples without carryover contamination. Disposable pipette tips are normally formed of a plastic material, such as polypropylene, and have a hollow, elongated, generally conical shape. The upper end of the pipette tip includes a collar that is mounted to a mounting shaft on the pipetting device. The mounting shaft is sometimes called the tip fitting. The mounting shaft or tip fitting includes an internal bore through which air is displaced in order to aspirate a liquid sample or reagent into the barrel of the pipette tip and then dispense the liquid sample or reagent from the pipette tip normally in another location. The distal end of the pipette tip has a small opening through which the liquid sample or reagent is received as it is aspirated into the barrel of the pipette tip and then dispensed.

Disposable pipette tips have historically relied on tapered fits between the mounting shaft and the pipette collar, as well as sealing rings on the inside circumference of the pipette collar, to secure and seal the pipette tips to the mounting shaft. With tapered fits, the seal between the mounting shaft and the disposable tip is achieved by pushing the tapered mounting shaft into the tapered collar until the mounting shaft wedges into the tip. At this point, a seal is achieved between the frustoconical tip collar and the mounting shaft as a result of crushing a sealing ring on the mounting shaft and/or stretching the diameter of the collar.

In addition to achieving a proper seal, it is also important that the position and orientation of the mounted pipette tip be stable in the face of lateral momentum or slight knocking forces that are typical during normal use such as during touch-off against the sidewall of a sample container. It is desired to minimize insertion and ejection forces in automated liquid handling systems, which often are configured to mount and eject 96 or 384 pipettes tips contemporaneously. Reducing the insertion forces and the ejection forces can reduce the size of the motor drives used in automated liquid handling systems, reduce system deformation, improve the tip z-position accuracy, otherwise improve the reliability of such systems, and also reduce the necessary amount of material and packaging in the tip rack.

Various systems have been devised to provide proper sealing and stability without requiring excessive insertion and ejection forces. U.S. Pat. No. 6,955,077, entitled “Pipette Tip with an Internal Sleeve and Method for Forming Same” and U.S. Pat. No. 7,047,828, entitled “Pipette Tip with Internal Sleeve and Stabilizing Projections,” both by Blaszcak et al. are directed to a pipette tip with a bifurcated or branched sidewall portion that extends annularly upward and serves to seal the pipette tip against the mounting shaft. The branched portion forming the seal extends slightly inward from the tip wall in the relaxed position. As the conical mounting shaft is pressed into the pipette tip, the shaft engages the branched portion, pushes laterally against the branched portion and a seal forms between the pipette tip and the shaft. These patents claim to reduce necessary insertion force to achieve similar sealing results as a standard pipette tip; however, the conical mounting shaft still needs to be inserted with enough force and to a sufficient depth to hold the tip tightly on the tapered mounting shaft. In other words, even though these patents describe a lateral seal, the tapered mounting shafts need to be pushed down into the collars of the tapered tips with enough force that the tips are secure and stable on the mounting shafts. These patents also claim to reduce potential ejection forces, however, the ejection force depends on how much force was used to mount the pipette tips in the first place.

The assignee of the present application has developed a reliable, ergonomic pipette tip mounting system described generally in U.S. Pat. No. 7,662,343 entitled “Locking Pipette Tip and Mounting Shaft,” issuing on Feb. 16, 2010; U.S. Pat. No. 7,662,344, also issuing on Feb. 12, 2010 and entitled “Locking Pipette Tip and Mounting Shaft;” U.S. Pat. No. 8,277,757 entitled “Pipette Tip Mounting Shaft” and issuing on Oct. 2, 2012; U.S. Pat. No. 8,501,118 entitled “Disposable Pipette Tip” and issuing on Aug. 6, 2013; U.S. Pat. No. 8,877,513 entitled “Method of Using a Disposable Pipette Tip” and issuing on Nov. 4, 2014; and U.S. Pat. No. 9,333,500 entitled “Locking Pipette Tip and Mounting Shaft in a Handheld Manual Pipette” and issuing on May 1, 2016, all incorporated herein by reference. In these patents owned by the assignee, the tip mounting shaft includes a locking section having circumferentially spaced outwardly extending locking lobes located above a stop which consists of a step spanning between the locking section of the mounting shaft and a lower sealing section of the mounting shaft having a smaller diameter. When the mounting shaft is fully inserted into the collar of a mating disposable pipette tip, the collar of the tip locks onto the mounting shaft. The bore of the pipette tip includes a circumferential shelf or shoulder separating its upper collar from the tip sealing area which is located below the circumferential shelf in the barrel of the tip. The tip collar includes a locking ring at or near the upper opening of the collar through which the mounting shaft is inserted. The dimensions of the collar, and in particular the distance between the circumferential shoulder and the locking ring, are selected to match the dimensions of the mounting shaft between the stop and a catch surface of the upper end of the locking lobes, thus locking the pipette tip in a secure, reliable position and orientation. The locking lobes include an inclining ramp portion that generally flexes and distorts the pipette tip collar out of round as the mounting shaft is inserted into the pipette tip over the locking ring, rather than stretching the tip collar, thereby reducing the amount of insertion force needed to mount the tip. The preferred tip mounting shaft has three or more lobes spaced equally around the mounting shaft with recessed relief portions spanning between the lobes to accommodate inward distortion of the tip collar between the lobes. As mentioned, the lobes include an inclining ramp that gently slopes between 10-20° with respect to the vertical axis of the mounting shaft. Each lobe extends outward along the ramp towards the top of the locking section of the mounting shaft until it turns inward to form a catch surface. In some embodiments, the lobes have a declining ramp past the peak of the lobe which reduces the required ejection force compared to an abrupt catch surface. When the mounting shaft is fully inserted into the pipette tip, the locking ring on the pipette collar engages the catch surfaces or declining ramps as it is fitted over the peaks of the lobes, thereby providing a secure, snapped-on mount. The peak of each lobe is preferably slightly rounded to facilitate removal of the pipette tip.

While the collar of the pipette tip is flexed and distorted out-of-round when the mounting shaft is inserted in the pipette tip, the circumferential shoulder on the pipette tip between the collar and the barrel of the tip isolates the sealing region at the upper end of the barrel from distortion. The structural isolation provided by the circumferential shoulder in the tip facilitates reliable sealing engagement between the lower sealing section of the tip mounting shaft and the sealing region in the upper end of the tip barrel. In some embodiments, a sealing ring on the pipette tip extends inward from the upper end of the tip barrel below the circumferential shoulder and engages a sealing region on the mounting shaft below the stop with an interference fit. In other embodiments, the mounting shaft includes a groove below the stop that holds a sealing ring such as an elastomeric O-ring. The O-ring on the tip mounting shaft engages a sealing region at the top of the tip barrel when the mounting shaft is fully inserted into the tip. The O-ring is typically used to further reduce insertion forces with larger tips that generally have higher insertion forces than smaller tips. In each of these cases, the sealing ring or region at the upper end of the tip barrel is isolated from distortion by the structural integrity of the circumferential shoulder on the pipette tip located between the distorted locking collar and the round tip barrel.

As described in the above referenced patents owned by assignee, the combination of the locking lobes and the stop on the mounting shaft results in an ergonomic, over-center locking engagement that provides tactile feedback to the user of a handheld pipettor indicating that the disposable pipette tip is approaching and has been fully engaged on the mounting shaft. When used in automated liquid handling systems, the over-center locking engagement provides precision, robust mounting and sealing of the array of tips As the mounting shaft is pushed into the tip collar, the first point of contact is where the leading edge of the mounting shaft, i.e., the lower sealing section, enters through the circumferential shoulder in the pipette tip and contacts the sealing region in the tip barrel. As the mounting shaft is further depressed into the pipette tip bore, the interference for the seal increases and the inclining ramp areas of the locking lobes on the mounting shaft engage the tip collar to distort the upper portion of the collar out-of-round. While the overall insertion force is relatively light and ergonomic compared to the prior art at the time, the force increases noticeably until the stop member on the mounting shafts engages the circumferential shoulder on the respective pipette tip to abruptly stop further movement of the mounting shaft relative to the tip. At this point the lobes also snap under the locking ring on the collar, e.g. with the locking ring on the tip engaging the catch surface or declining ramp of the lobes thus holding the tip securely in place on the mounting shaft. These interrelated mounting conditions result in a secure, stable mount with consistent sealing. In addition, the flexing of the collar into a distorted shape stores energy in the collar when it is mounted. To eject the tip from the mounting shaft, downward ejection force is required to release the locking ring on the collar from the locking lobes on the mounting shaft. In general, the downward ejection force causes the collar to distort further outward at the lobes so that the locking ring can slide down over the peak of the respective lobes, and then release downward. When the tip is released from the lobes, the combination of the downward force from the pipette tip stripping mechanism and the stored energy in the distorted tip collar acting against the lobe geometry tend to throw the tip from the mounting shaft, thereby facilitating convenient ejection of the tips from the mounting shaft after use. While the above tip mounting system described in assignee's previous patents provided a significant advancement in the art, it is desirable to further lessen tip insertion forces without substantially affecting the stability of the mounted pipette tips.

Pipette tip racks are used to organize disposable pipette tips in a manner that is convenient to mount the tips onto a pipette mounting shaft or fitting. The racks typically include a plastic tip insert with an array of holes, such as an 8×12 array or a 16×24 array, through which the pipette tips hang with the tip collars exposed upward. Conventional racks for automated liquid handling systems comprise a substantially rigid box suspending the plastic tip insert at a height sufficient for the pipette tips to pass through the holes and be suspended by their collar. The rigidity of the box is important to hold the pipette tips in a stable position when loading the tips onto mounting shafts on automated equipment. Typically, the box has several reinforcement support ribs extending upward from the bottom wall of the box to support the plastic tip insert from underneath. This support is especially important when loading 384 tips simultaneously onto an array of mounting shafts as the cumulative required loading force causes the plastic tip insert to bow in the middle if left unsupported or under supported. The bowing results in some tips not being properly mounted. When loading 96 tips simultaneously, the overall forces are not generally as great, but one or more support reinforcement ribs are still needed in most designs.

Tip racks also have a removably cover that is usually transparent and removed prior to loading the tips onto the array of mounting shafts. Liquid handling equipment will include a nest, e.g. having SBS standard dimensions, in which the user sets the tip rack before loading the tips on to the array of mounting shafts. The array of holes in the plastic tip insert are typically arranged according to standard SBS dimensions (9 mm centerline spacing for 96 tips and 4.5 mm for 384 tips), so that the automated liquid handling equipment can lower the pipetting head with the array of mounting shafts to mount the tips simultaneously.

The use of rigid tip racks can lead to substantial plastic waste in the laboratory. Some laboratories choose to purchase tips sold in bulk in bags to reload used tip racks manually, but this is a time-consuming process and is not a viable option for sterile applications. It is also known to sell refill packs with tips loaded in plastic tip inserts, without the bottom receptacle of the rack, which in turn are loaded by the user into the previously used tip rack or into a reusable base. While refill packs without the bottom receptacle are helpful to many customers, these kind of refill packs are not desirable in highly sterile applications. It is known to package multiple refill packs in stacks with tips from a stacked refill pack being partially nested into the tips of the lower refill pack. For refill packs of tips packaged in paperboard, paper fragments can compromise experiments. Many customers needing sterile pipette tips and packaging are left with no choice but to use rigid tip racks that are able to withstand the high cumulative tip mounting forces when mounting the tips in robotic systems with 96 or 384 mounting shafts, which can lead to substantial waste that needs to be stored in the laboratory prior to disposal or recycling.

Applicant owns U.S. Pat. No. 11,850,596, entitled “Pipette Tip Rack System,” by Bonnoitt, et al., which issued on Dec. 26, 2023. The '596 patent discloses the use of tip dispenser meant to sit on a laboratory bench top into which a recyclable thermoformed container filled with pipette tips is placed, for loading the tips onto hand-held pipettes. The container and the tip dispenser each have hinged covers or lids so that the container can be kept closed in between the user loading tips onto the hand-held pipette. It is also known to provide a reusable base (without the hinged cover) for the recyclable pipette tip containers designed for hand-held use. The system in the '596 patent is not generally strong enough to withstand the forces that occur in automated robotic applications. Other companies make recyclable or disposable tip containers that are supported by a rigid reusable base, as well, but such systems are directed to use with hand-held pipettes where the cumulative loading forces are significantly less than in automated robotic systems.

### SUMMARY OF THE INVENTION

The invention relates to a pipette tip rack system that packages the pipette tips in a disposable refill pack configured to keep the pipette tips sterile until use in the laboratory. The refill pack is set in a sturdy reusable base which in turn is placed in a nest on the automated or semi-automated liquid handling equipment in order to load the tips. The bottom peripheral wall of the reusable base desirably has outer nesting dimensions in accordance with SBS standards. The refill pack can be disassembled easily after use so that its components (receptacle, support rib, plastic tip insert, cover) can be nested or stacked in a space savings manner prior to being recycled or disposed. The structural integrity of the disposable refill pack and keeping the plastic tip insert from bowing when loading 96 or 384 tips simultaneously, requires a reduction of tip insertion forces from the levels in the prior art.

As such the pipette tips, the disposable refill pack including the plastic tip insert as well as the reusable base are a system which works only in combination. The inventors have designed a pipette tip that reduces the tip loading force sufficiently to allow the weight of the refill pack to be reduced without sacrificing the stability of the refill pack and the plastic tip insert, when placed in the reusable base. The refill pack is not configured to withstand loading forces of the liquid handling equipment, especially those with 96 or 384 heads, and therefore the strength and stability to withstand the necessary loading forces is afforded to the system in large part from the reusable base.

The inventors have designed a pipette tip that reduces the tip loading forces sufficiently to enable the reliable use the claimed disposable refill pack with the claimed reusable base, when robotically loading 96 tips or 384 tips. Other mounting shaft/tip configurations and materials may be found to reduce the require insertion forces in the future, and the disposable refill pack configured in accordance with the invention should be useful in those circumstances as well.

The pipette tip rack system is configured to be used in robotic liquid handling systems but can be used for handheld applications if desired.

The refill pack as mentioned is configured to be disposable and is configured so that the reusable base supports the periphery of plastic tip insert, and a removeable support rib supports the center of the plastic tip insert, when the refill pack is loaded in the reusable base to loading arrays of 96 or 384 pipette tips simultaneously. The refill pack has a tip receptacle or liner with a bottom wall, lateral sidewalls, a front sidewall and a back sidewall. The plastic tip insert spans over the well and has a peripheral skirt supported by the sidewalls of the tip receptacle for packaging purposes. The tip receptacle defines a well for storing the barrel portions of pipette tips underneath the plastic tip insert. The plastic tip insert has an array of holes for holding the array of pipette tips with the centerline of the respective holes spaced apart from one another at a spacing of 4.5 mm for arrays of 384 pipette tips or 9 mm for arrays of 96 pipette tips, as is standard in the art. The pipette tips are held substantially vertically with collars of the respective pipette tips facing upward to facilitate mounting of the pipette tips onto an array of pipette mounting shafts on a robotic liquid handling system or if desired onto a handheld pipette. The plastic tip insert is removably attached to the tip receptacle, so that it can be easily dissembled and stacked after the pipette tips have been mounted and removed from the tip rack system.

A removable cover on the disposable refill pack covers the plastic tip insert and the collars of pipette tips held in by the plastic tip insert. The cover and the tip receptacle keep the pipette tips sterile if the tips are meant to be sterile. The cover is desirably transparent or clear so that the user can see the pipette tips and also the color of the plastic tips insert. The color of the plastic tip insert is desirably coded to represent the size and/or type of mounting shaft compatible with the pipette tips.

A vertical support rib is located in the well of the tip receptacle. The vertical support rib sets in one or more vertical rib mounts extending up from the bottom wall of the tip receptacle. Desirably, there is one mount at the front side and one at the back side, and the mounts are molded to be integral with both bottom wall and the respective front or back side wall. The vertical support rib extends upward from the bottom wall of the tip receptacle to a bottom surface of the plastic tip insert. The vertical support rib is removable from the vertical rib mounts and from the tip receptacle, when the refill pack is dissembled after use. The vertical support rib can be placed flat in the well of the tip receptacle after it is removed from the mounts in order to facilitate stacking and nesting of used tip receptacles.

The refill pack is set in the reusable base such that the sidewalls of the base support the peripheral skirt of the plastic tip insert when the pipette tips are being mounted onto the array of pipette mounting shafts on the robotic liquid handling system. The bottom wall of the reusable base supports the vertical support rib and in turn the bottom surface of the plastic tip insert when pipette tips are mounted onto the array of pipette mounting shafts on the robotic liquid handling system. The vertical support rib keeps the plastic insert from bowing under the cumulative loading pressure. It is desirably located equidistant from the lateral sidewalls of the tip receptacle.

In the preferred embodiment of the invention, the plastic tip insert has several structural features to facilitate precise placement of the refill pack into the reusable base and also facilitate the convenient disassembly of the refill pack after use. The tip receptacle has a peripheral horizontal rim extending outward from a top of its sidewalls. The peripheral rim includes snap-fit holes adjacent each lateral sidewall for snap fitting on the plastic tip insert. The snap fittings have a groove on the outer surface that receive the peripheral rim of the tip receptacle and have a vertical slot so that each side can be compressed to attach plastic tip insert to the peripheral rim of the tip receptacle or to remove the plastic tip insert after use. The lateral sidewalls of the reusable base also have holes on top of each lateral sidewall for the snap fittings on the plastic tip insert, although it is desired that that distal ends of the fittings fit into the holes but do not snap engage the reusable base. The plastic tip insert also desirably has guidepost extending down from the peripheral skirt, near the corners to facilitate proper alignment of the refill pack as it is placed in the reusable base. The lateral sidewalls of the reusable base desirably have guide holes on top of each lateral sidewall for the respective guideposts.

The plastic tip inserts are configured to be stackable when disassembled from the tip receptacle. For example, the top of the plastic tip insert desirably has enlarged indentions to capture the guideposts and snap fittings of a plastic tip insert stacked on it. Also, to facilitate space saving stickability, an outer surface of opposed sidewalls of the tip receptacle desirably have vertical stacking ribs extending from the peripheral rim partially down the respective sidewall. The reusable base has slots for the vertical stacking ribs, which also help to stabilize the tip receptacle in the reusable base when loading tips.

As explained above, the above construction for the refill pack can be used only if the cumulative loading force does not cause the plastic tip insert to bow. The exemplary 384 refill pack described in FIGS. 18-34 is capable of withstanding a cumulative loading force of 3,072 N (maximum loading force of 8 N per 125 μl tip) without the plastic tip insert or the vertical support rib failing. 125 μl tips or similar sized tips in the prior art are not capable of loading for less than 8 N, and therefore tip racks for similar prior art tips need to be able to withstand much higher cumulative loading forces than the 3,072 N that the exemplary 384 refill pack described in FIGS. 18-34 is configured to withstand. For larger pipette tips, such as 1250 μl tips or similar sized tips, the inventive sealing configuration can result in a maximum loading force of 10 N per 1250 μl tip. 1250 μl tips are packaged in arrays of 96 such as using the exemplary 96 refill pack described in FIGS. 35-42, which even though taller than the exemplary 384 refill pack described in FIGS. 18-34, are configured to withstand the cumulative loading force of 960 N at a minimum. As explained above, the inventors have designed a pipette tip that reduces the tip loading forces sufficiently to enable the reliable use the claimed disposable refill pack when robotically loading 96 tips or 384 tips. Exemplary embodiments of the improved pipette tip are discussed in connection with FIGS. 2-17.

The improved pipette tip is configured to mount on a tip fitting or mounting shaft having circumferentially spaced, outwardly extending locking lobes. In the above incorporated patents owned by the assignee, the pipette tip seals against the mounting shaft below a circumferential shoulder of the tip between the collar and barrel of tip, i.e., the seal occurs in the upper portion of the tip barrel. The improved pipette tip is modified and has a circular cantilever sealing ring at the circumferential shoulder between the tip collar and the barrel. The circular cantilever sealing ring has a laterally resilient, annular sealing wall that extends from the circumferential shoulder on the pipette tip towards the collar opening and has an apex that abuts against the stop on the mounting shaft to provide tactile feedback that the pipette tip is fully mounted so that the user does not use excessive force in an attempt to force the pipette tip tighter onto the mounting shaft. The annular sealing wall of cantilever sealing ring slants inward slightly as it extends upward from its base. The upper portion of the annular sealing wall is displaced laterally and radially outward when the mounting shaft is inserted and forms a lateral interference seal against the mounting shaft immediately below the stop on the mounting shaft. There is an annular gap between the annular sealing wall and the tip collar. The gap enables the annular sealing wall to move laterally outward without requiring the collar to stretch, which reduces required insertion forces compared to assignee's prior art pipette tips. In addition, the sealing region on the mounting shaft is preferably cylindrical, and the inside diameter immediately below the annular sealing wall of the cantilever ring seal is preferably chosen to have zero interference with the cylindrical sealing region of the mounting shaft, to help further reduce required insertion forces.

It has been found that pipette tips incorporating the circular cantilever sealing ring require substantially less insertion force and less ejection force than prior pipette tips made by assignee. For larger tips, it may be desirable to use an O-ring in the sealing region of the mounting shaft to further reduce insertion forces, however, it is contemplated that O-rings will not be necessary even with larger tips because the configuration of the circular cantilever sealing ring reduces insertion forces significantly compared to previous sealing methods.

The presence of the circumferential shoulder of the pipette tip maintains the circular shape at the base of the circular cantilever sealing ring even when the collar is otherwise being distorted out-of-round to lock over the lobes on the mounting shaft. Similar to assignees prior pipettes, each of the locking lobes on the pipette tip mounting shaft includes an inclining ramp portion that angles outward as the inclining ramp extends upward along the mounting shaft. The purpose of the inclining ramp portion of the lobes is to facilitate distortion of the pipette tip collar out-of-round as the mounting shaft is inserted into the pipette tip. Relief portions spanning between the outwardly extending lobes and recessed with respect to the lobes accommodate inward distortion of the pipette tip collar between the lobes as in the prior art. Accordingly, when a pipette tip is mounted to a mounting shaft in accordance with the invention, the collar of the pipette tip is distorted out-of-round but the circumferential shoulder of the pipette tip between the collar and the barrel remains substantially circular and undistorted. The structural integrity of the circumferential shoulder on the tip in turn maintains the circular and undistorted shape of the base of the circular cantilever sealing ring.

Preferably, each of the locking lobes includes a peak portion that is located at a maximum outward distance from the longitudinal axis of the mounting shaft as well as a declining ramp portion that angles inward towards the longitudinal axis on the mounting shaft as it extends upward away from the peak of the lobe along the mounting shaft. However, the invention can be implemented with a mounting shaft having more abrupt catch surfaces on the locking lobes than a gently declining ramp. Also preferably, the mounting shaft has three or more locking lobes. It is preferred that the lobes comprise less than 15% of the circumference of the mounting shaft at the peak portion of the lobes with the remaining portion of the circumference of the mounting shaft being consumed by relief portions between the lobes. This configuration with relatively thin locking lobes helps to reduce friction between the tip collar and the mounting shaft and reduces insertion and ejection forces, while at the same time provides stable over-center mounting of the tip over the lobes.

The pipette tips described in FIGS. 2 through 17 can be used in connection with handheld, single-channel and multi-channel pipettes, as well as automated and semi-automated liquid handling equipment that robotically load an array or matrix of multiple disposable pipette tips simultaneously. The use of the described lobes and the stop on the mounting shaft ensures that each of the pipette tips in a multi-channel application are mounted to the same height and aligned properly. As described in more detail below in reference to the drawings, the pipette tip and mounting shaft configuration of the present invention lowers required insertion an ejection forces without substantially affecting stability of the tips mounted on the mounting shaft under normal operating conditions, and this reduction in loading force enables the use of the disposable refill packs described above to simultaneously load the tips even when containing 384 pipette tips in the package.

These and other aspects, features and advantages of the invention are now described in greater detail with reference to the accompanying drawings.

### BRIEF DESCRIPTION OF THE DRAWINGS

FIG. 1 is a manually-directed 384-well robotic pipetting instrument using pipette tips and a pipette tip rack system configured in accordance with the present invention.

FIG. 2 is a perspective view showing a disposable pipette tip and tip mounting shaft constructed in accordance with an exemplary embodiment of the present invention.

FIG. 3 is a side elevational view of the mounting shaft and pipette tip shown in FIG. 2.

FIG. 4 is a longitudinal cross-section taken along line 4-4 in FIG. 3.

FIG. 5 is a detailed view of an area encircled by line 5-5 in FIG. 4 showing an upper locking collar, a circumferential shoulder and a circular cantilever sealing ring on the disposable pipette tip.

FIG. 6 is a detailed view of the area encircled by line 6-6 in FIG. 4 showing a locking section, a cylindrical sealing section and a stop of the tip mounting shaft.

FIG. 7 is a side elevational view showing the mounting shaft being inserted into the disposable pipette tip.

FIG. 8 is a longitudinal cross-sectional view taken along line 8-8 in FIG. 7.

FIG. 9 is a detailed view over the area encircled by line 9-9 in FIG. 8 showing insertion of the mounting shaft into the pipette tip just prior to final engagement.

FIG. 10 is a detailed view similar to FIG. 9 showing full insertion of the mounting shaft into the pipette tip.

FIG. 11 is a view taken along line 11-11 of FIG. 10 illustrating the pipette tip collar and locking ring being distorted out-of-round when the pipette tip is fully mounted onto the mounting shaft.

FIG. 12 is a view similar to FIG. 10 illustrating the pipette tip being ejected from the mounting shaft.

FIGS. 13a-c are schematic views illustrating the interaction between an annular wall of the circular cantilever sealing ring on the pipette tip and a cylindrical sealing area on the pipette mounting shaft as the mounting shaft is inserted into the tip collar.

FIG. 14 is an enlarged cross section of the circular cantilever sealing ring and the stabilizing ring in a disposable pipette tip molded in accordance with the exemplary embodiment of the invention.

FIG. 15 contains data illustrating that using a tip mounting shaft and a disposable pipette tip constructed in accordance with the exemplary embodiment of the invention substantially reduces insertion forces.

FIG. 16 shows an alternative embodiment of the mounting shaft in which the sealing area on the mounting shaft has O-ring.

FIG. 17 shows a structural analysis of a tip configured in accordance with the exemplary embodiment of the invention subject to lateral displacement at the dispensing end of the tip, as is a standard pipetting practice when touching off tips.

FIG. 18 is a perspective view of pipette tip rack system for a robotic liquid handling system constructed in accordance with a first exemplary embodiment of the invention.

FIG. 19. is an assembly view of the tip rack system in FIG. 18.

FIG. 20 is a perspective view of a disposable tip refill pack being inserted into a reusable base in accordance with one aspect of invention.

FIG. 21 is a perspective view of a disposable tip receptacle or liner constructed in accordance with the first exemplary embodiment of the invention.

FIG. 22 is a side elevational view of the disposable tip receptacle illustrated in FIG. 21.

FIG. 23 is a top view of the disposable tip receptacle shown in FIGS. 21 and 22.

FIG. 24 is a top perspective view of a plastic tip insert constructed in accordance with the first exemplary embodiment of the invention.

FIG. 25 is a lower perspective view of the plastic tip insert shown in FIG. 24.

FIG. 26 is a top view of plastic tip insert shown in FIGS. 24 and 25.

FIG. 27 is detailed view showing the insertion of the disposable tip refill pack into the reusable base.

FIG. 28 is perspective view of the disposable tip refill pack of the first exemplary embodiment loaded with pipette tips in the plastic tip insert and set into the reusable base, with the cover removed to enable mounting of the pipette tips onto a robotic liquid handling system.

FIG. 29 is the disposable tip refill pack of FIG. 28 sitting in the reusable base after the pipette tips have been mounted and removed.

FIG. 30 is a sectional view taken along line 30-30 in FIG. 29.

FIG. 31 is a perspective view showing the plastic insert being removed from the disposable tip receptacle.

FIG. 32 is a perspective view of the disposable tip receptacle with the removable vertical support rib being removed.

FIG. 33 is a schematic view showing stacking of disposable tip receptacles constructed in accordance with the first exemplary embodiment of the invention compared to stacking of prior art racks.

FIG. 34 is a sectional view of the stack of disposable tip receptacles taken along line 34-34 in FIG. 33.

FIG. 35 is a perspective view of pipette tip rack system for a robotic liquid handling system constructed in accordance with a second exemplary embodiment of the invention.

FIG. 36. is an assembly view of the pipette tip rack system in FIG. 37.

FIG. 37 is a side elevational view of a disposable tip receptacle constructed in accordance with the second exemplary embodiment of the invention.

FIG. 38 is a top view of the disposable tip receptacle illustrated in FIG. 40.

FIG. 39 is a lower perspective view of the disposable tip receptacle illustrated in FIGS. 37 and 38.

FIG. 40 is a top view of a plastic tip insert constructed in accordance with the second exemplary embodiment of the invention to hold 96 pipette tips.

FIG. 41 is a lower perspective view of the plastic tip insert shown in FIG. 40.

FIG. 42 is a sectional view showing components of the tip rack system constructed in accordance with a second embodiment of the invention.

FIG. 43 is a schematic view showing stacking of disposable tip receptacles constructed in accordance with the second exemplary embodiment of the invention compared to a stack of prior art racks.

FIG. 44 is a sectional view of the stack of disposable tip receptacles taken along line 44-44 in FIG. 43.

### DETAILED DESCRIPTION OF THE INVENTION

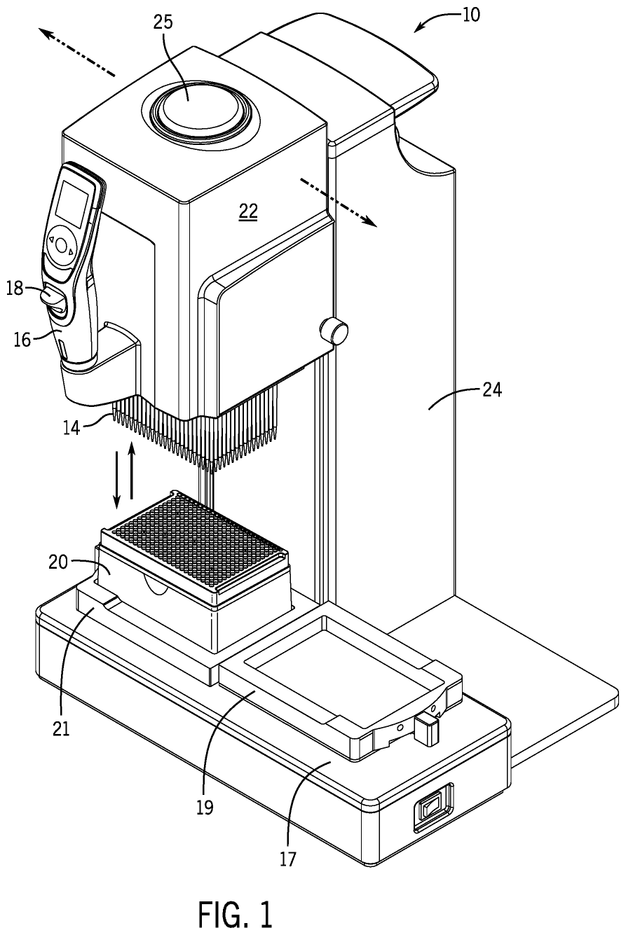

FIG. 1 illustrates a manually directed, 384-channel robotic pipetting system 10. Specifics of how the robotic pipetting system 10 operates are disclosed in U.S. Pat. No. 8,367,022, entitled “Unintended Motion Control for Manually Directed Multi-Channel Electronic Pipettor,” by Warhurst et al., issuing on Feb. 5, 2013 and incorporated herein by reference; and U.S. Pat. No. 8,372,356, entitled “Manually Directed, Multi-Channel Electronic Pipetting System,” by Warhurst et al., issuing on Feb. 12, 2013 and also incorporated herein by reference. Briefly, the robotic pipetting system 10 is shown with an array of 384 disposable pipette tips 14 mounted onto an array (16×24) of mounting shafts 12 on a pipetting head attached to the system 10. The tip mounting shafts 12 are constructed in accordance with an exemplary embodiment of the invention, as discussed below, and so are the disposable pipette tips 14. When mounting an array of pipette tips 14 simultaneously onto an array of mounting shafts 12, the required cumulative insertion force is significantly greater than with a single channel, hand-held pipette or even an 8-, 12- or 16-channel hand-held pipette. In fact, the cumulative insertion force to attach 384 tips simultaneously is significantly more than 96 tips, although it is contemplated that invention is pertinent to 96 channel systems as well as 384 channel systems. The robotic pipetting system 10 in FIG. 1 has a vertical drive mechanism that is used to raise and lower the pipetting head and generate enough force for simultaneous insertion into 96 or 384 tips. It is known in robotic pipetting systems, whether manually directed like the system 10 in FIG. 1, or fully automated like many other laboratory liquid handling systems, to have a vertical drive mechanism to raise and lower the pipetting head with enough force to simultaneously mount 96 or 384 pipette tips. The pipette tip rack system 20 and the pipette tips 14 and mounting shafts are useful for fully automated laboratory liquid handling systems as well as semi-automated, manually directed systems like that shown in FIG. 1. The pipette tip rack 20 can be used for handheld pipetting but the rack 20 is especially made to meet the rigors of robotically loading arrays of pipette tips simultaneously.

The robotic pipetting system 10 in FIG. 1 has a flat deck 17 supporting a right-side nesting receptacle 19 and a left-side nesting receptacle 21. The nesting receptacles 19, 21 are deigned to hold microtiter plates, reagent reservoirs, or pipette tip racks in known locations on the deck 17. The nesting receptacles 19, 21 desirably have dimensions defined by SBS standards as is known in the art. FIG. 1 shows a pipette tip rack system 20, which is constructed in accordance with a first exemplary embodiment of the invention, set in the left-side nesting receptacle 21. The pipette tip rack 20 holds 384 pipette tips which in FIG. 1 have been mounted to a pipetting head attached to a carriage 22 of the robotic pipetting system 10. The carriage 22 is mounted to a tower 24. In some systems, the pipetting head is replaceable, which would enable the customer to switch between 384 and 96 channel heads for example if desired. A pipetting motor located within the carriage 22 drives the multi-channel pipetting head to aspirate and dispense. A Z-axis vertical drive mechanism moves the carriage 22 and the multi-channel pipetting head vertically with respect to the tower 24 and the deck 17. An X-axis drive mechanism moves the tower 24 and the carriage 22 horizontally along an X-axis so that the pipetting head and the array of tips 14 can be moved over the right-side nesting receptacle 17 on the deck 16 or over the left-side nesting receptacle 21 on the deck 17.

The system 10 includes a control handle 16 mounted to the carriage 22 and resembling a handle for a handheld electronic pipettor. In use, the user grasps the control handle 16 in the manner similar as when using a handheld pipette and exerts pressure on the control handle 16 to direct movement of the carriage 22 and the pipetting head. The vertical Z-axis motion and the horizontal X-axis motion are driven by independent motors under servo control. The control handle 16 in system 10 also includes a user interface for controlling pipetting functions such as aspirating and dispensing.

To mount the pipette tips, the pipetting head with the array of tip mounting shafts is aligned precisely over the tip rack 20 located on deck 17 using the X-axis horizontal drive mechanism. Then, the Z-axis vertical drive mechanism is used to lower the carriage 22 and the tip mounting shafts 12 with sufficient force to attach the array of pipette tips 14 held in the pipette tip rack 20. The carriage 22 and the pipetting head are then raised using the Z-axis vertical drive mechanism to remove the tips 14 from the tip rack 20. The tip rack 20 is then removed from the nesting receptacle 21 on the deck 17 and replaced with a well plate or reservoir in order to transfer fluids.

For tip attachment as with regular motion control, the general horizontal and vertical motion of the carriage 22 and pipetting head is controlled by the user by holding the controller 16 in their palm and applying pressure in the appropriate direction to position the pipetting head over the rack 20 of pipette tips 14. Biasing motion control software can be used to achieve precise alignment necessary for tip attachment. Once the pipetting head and the tip mounting shafts 12 are aligned, the handle control 16 is disabled and an automated tip attachment routine is used to provide sufficient downward force to attach the tips 14 to the mounting shafts 12, and also lower the mounting shafts to the appropriate height. As a safety precaution, the automated tip attachment routine can be activated only when one of the user's hands depresses the button 25 on the top of the carriage 22 and the other hand is detected to be present on the handle 16.

Internal components in the carriage 22 drive pistons that each extend through a seal assembly to displace air within an aspiration and dispensing cylinder. The tip mounting shafts 12 are attached to the pipetting head such that each shaft is in fluid communication with one of the aspiration and dispensing chambers. The user interface on the handle 16 includes a thumb wheel control, run button and a display. The handle 16 also includes a lever or ejection button 18 that is pushed downward to activate downward movement of an ejection plate on the pipette head. The ejection plate desirably is stepped so that the tips are ejected in stages thereby reducing the required ejection force.

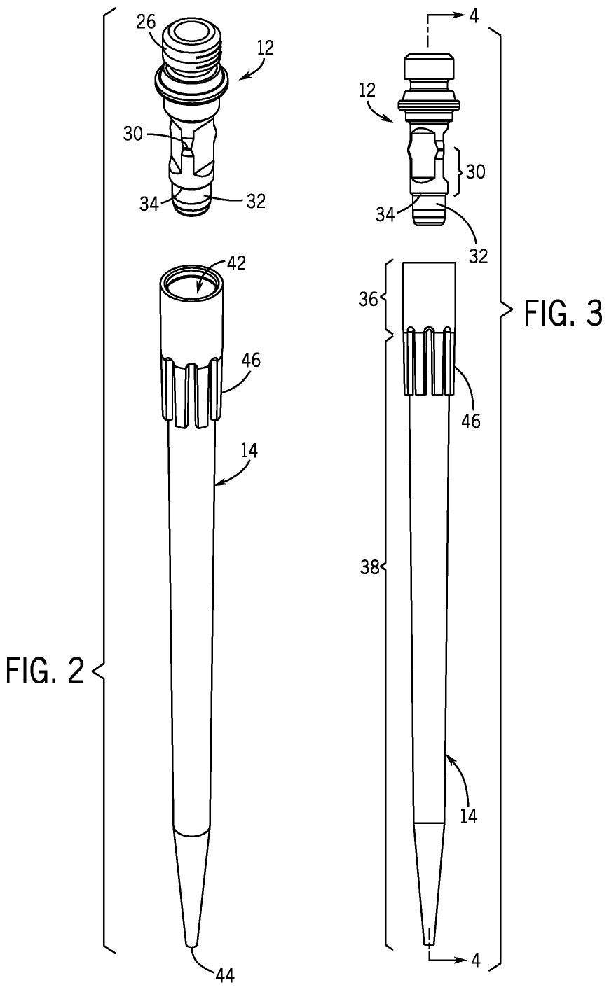

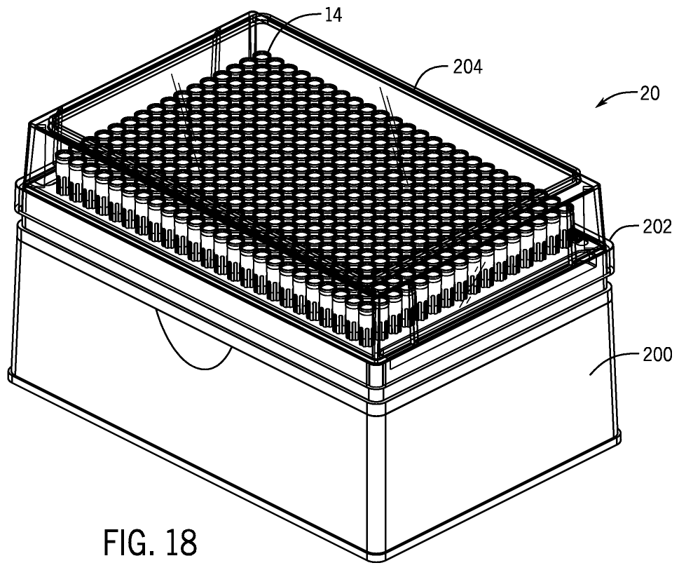

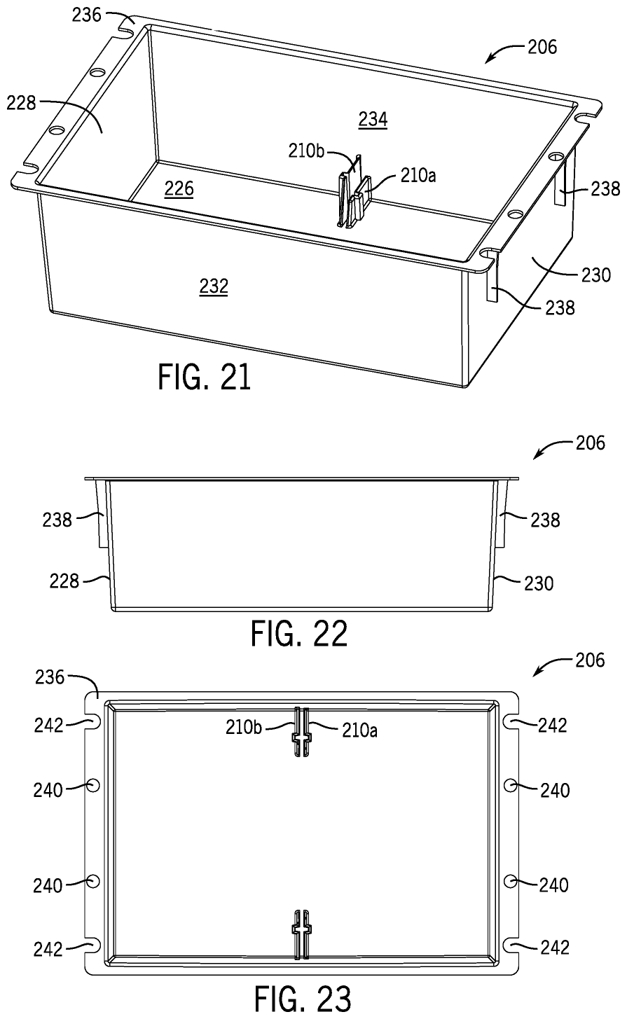

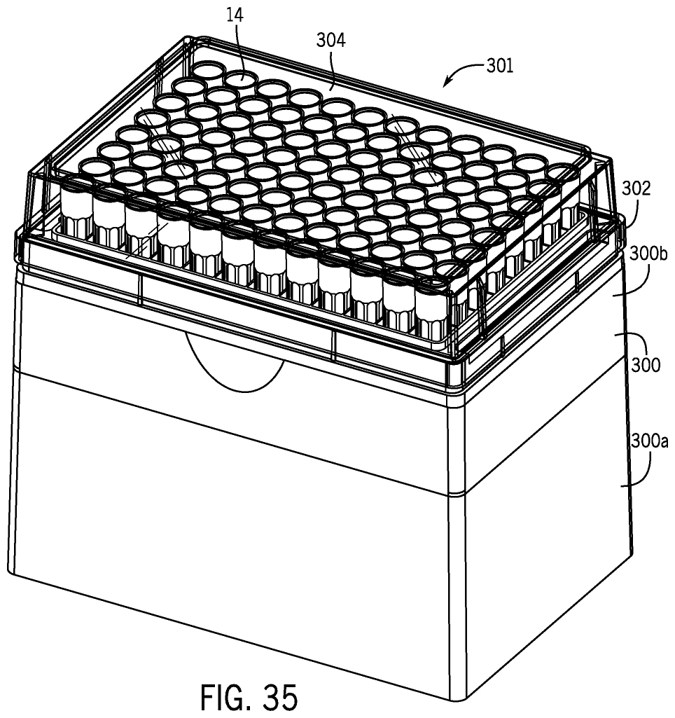

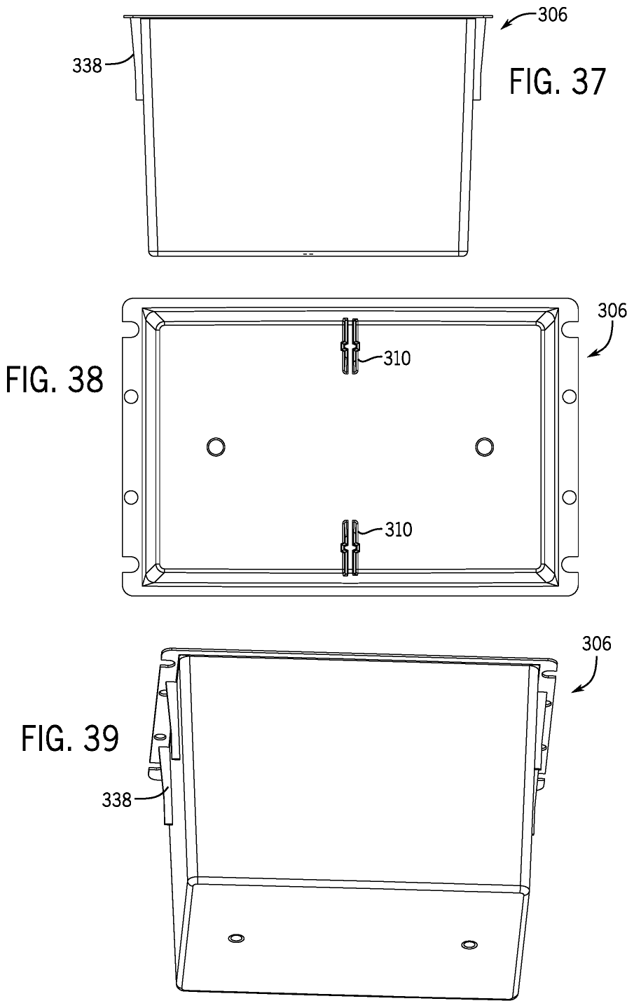

The pipette tip rack system 20 in FIG. 1 holds 384 pipette tips 14 and is a first embodiment of the pipette tip rack system that is shown in more detail in FIGS. 18 through 36. A second embodiment of the pipette tip rack system 301, holding 96 pipette tips 14, is shown in FIGS. 35 through 42. As mentioned above, the tip rack system uses a disposable tip refill pack and a reusable base to provide sufficient strength to hold the plastic tip insert in a level plane even when simultaneously mounting 96 or 384 pipette tips 14. In one aspect, the invention relies on the use of mounting shaft and pipette tip pairs that require relatively low insertion force. The mounting shaft 12 and pipette tip 14 illustrated in FIGS. 2 through 17 provides low insertion forces, and robust reliable sealing.

As shown in FIG. 2, the mounting shaft 12 in this exemplary embodiment has threads 26 for attaching it to the lower end of the aspiration and dispensing cylinder (not shown) on the pipetting head of the robotic liquid handling system 10. The dimensions of the mounting shaft 12 match the dimensions of the pipette tip 14 so that only pipette tips 14 with the proper dimensions fit onto the mounting shaft 12 and engage properly. For example, even if the pipette tips are constructed in accordance with the invention, if one chooses to use pipette tips with a different bore dimension in the collar or sealing region, it is necessary to replace the pipetting head with a new pipetting head with mounting shafts 12 having appropriate dimensions for the tips 14 being mounted and used. The pipetting head and the tip storage rack are desirably color coded so that the user can easily identify that the tips assignee's tips and have the proper collar to fit on the respective mounting shaft. The color coding can be implemented by color coding the various plastic tip insert configurations.

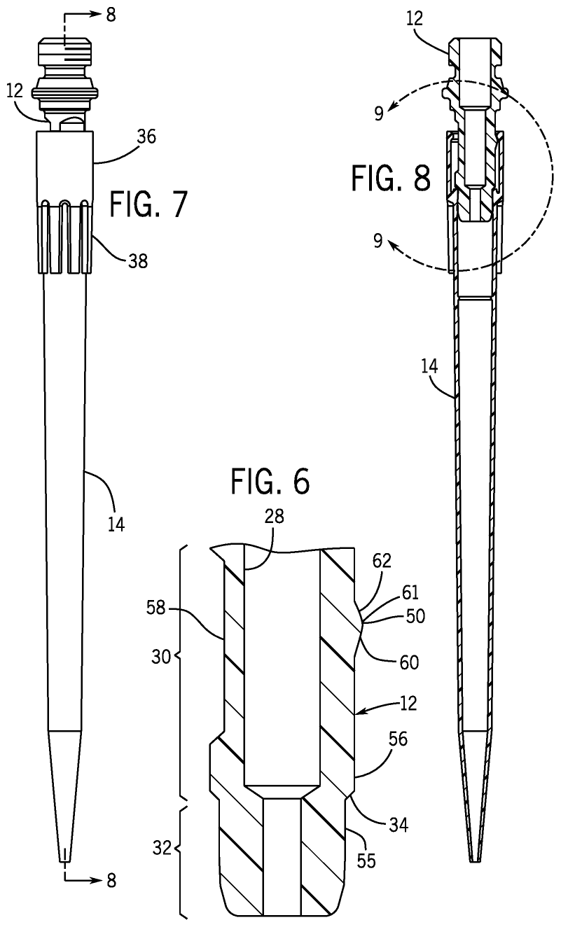

Referring now in general to FIGS. 2-6, the mounting shaft 12 contains a central bore 28 (FIG. 6) for air to pass between the aspiration and dispensing cylinder in the pipette 10 and the pipette tip 14, as is well known in the art. The pipette mounting shaft 12 includes an upper locking section 30, a lower section 32, and a stop 34 located between the upper locking section 30 and the lower section 32. Sealing occurs in the area 55 of the lower section 32 immediately below the stop 34 (see FIG. 6). The locking section 30 of the mounting shaft 12 has outwardly extending locking lobes 50 and recessed areas 58 (see e.g., FIG. 6) spanning between the locking lobes 50.

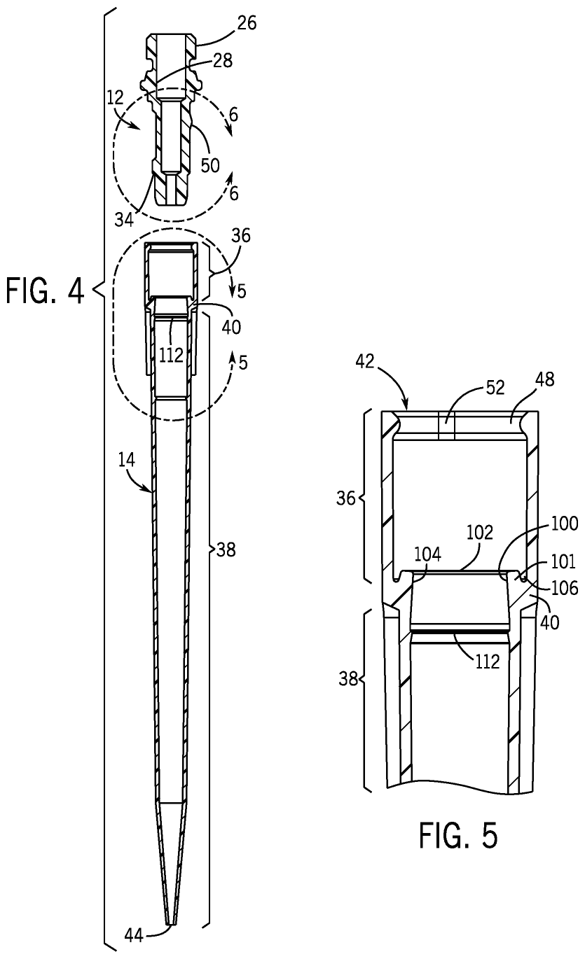

The pipette tip 14 generally consists of a collar 36, a barrel 38 and circumferential shoulder 40 (see e.g., FIGS. 4 and 5) that extends around the inside bore of the tip 14 and connects the lower end of the collar 36 to the upper end of the barrel 38. The upper end of the collar 36 has an opening 42 to receive the pipette mounting shaft 12. The lower end of the barrel 38 has a small opening 44 through which liquid is aspirated into the tip barrel 38 and dispensed from the tip barrel 38 during normal operation of the pipette 10. Support ribs 46 (FIG. 3) extend downward on the outside surface of the disposable pipette tip 14 from the collar 36. The support ribs 46 function to hold the tip 14 or an array of tips 14 in a rack for subsequent use and mounting, as is known in the art.

The preferred configuration of the pipette tip 14 is described now in reference to FIG. 5. A circumferential locking ring 48 is preferably located on inside surface of the collar 36 of the pipette tip 14. The locking ring 48 is located at or slightly below the opening 42 in the collar 36 through which the mounting shaft 12 is inserted. The locking ring 48 extends inward from the inside wall of the collar 36 a slight amount, preferably in the range of 0.025 to 0.25 mm, in order to provide an over-center locking fit over the peak 61 of the lobes 50 on the mounting shaft 12 (see FIG. 6). The locking ring 48 can contain an optional air bleed 52 although such an air bleed is not necessary in most circumstances because the distortion of the collar 36 when the tip is mounted should normally provide sufficient clearance over the recessed areas 58 of the mounting shaft 12. The inside surface of the collar 36 is preferably slightly tapered or slightly frustoconical but can also be cylindrical. The preferred taper is between 0° and 10°. In any event, horizontal cross-sections through the main section of the collar 36 are circular.

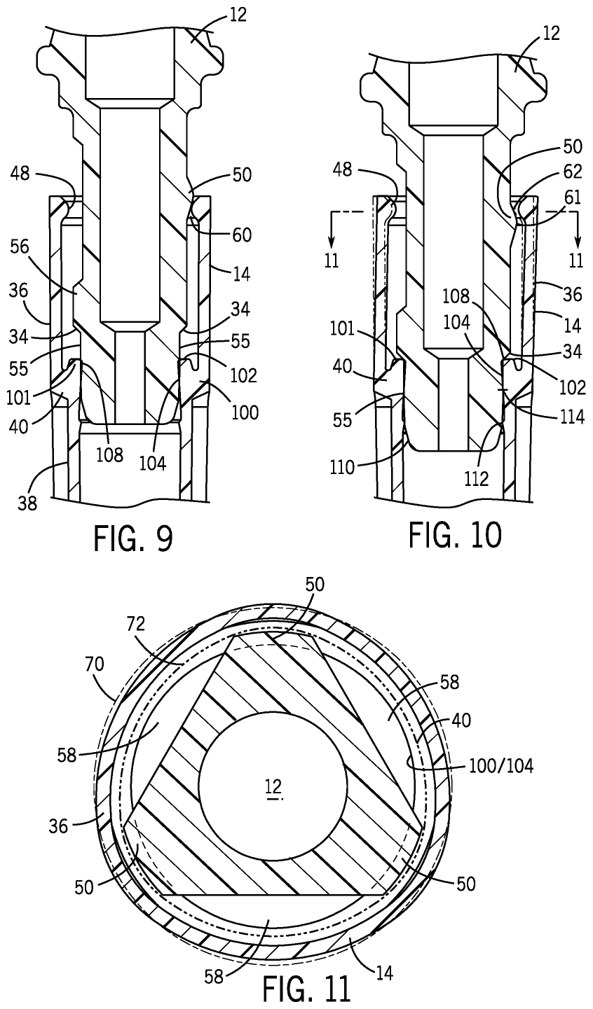

As mentioned, the circumferential shoulder 40 on the tip 14 connects the lower end of the collar 36 to the upper end of the barrel 38. A circular cantilever sealing ring 100 includes a resilient annular wall 101 that extends from the tip shoulder 40 towards the collar opening 42. The purpose of the laterally resilient annular wall 101 is to laterally engage and seal against the cylindrical sealing area 55 (see FIG. 6) on the mounting shaft 12 when the tip 14 is fully mounted to the mounting shaft 12. The annular wall 100 has an upper free end 102 that abuts the stop 34 on the pipette mounting shaft 12 when the tip 14 is fully mounted to the mounting shaft 12, see e.g., FIGS. 9 and 10.

The collar 36 of the disposable pipette tip 14 is sufficiently flexible to distort outwardly at the lobes 50 on the mounting shaft 12 and inwardly at the recessed relief portions 58 on the mounting shaft between the lobes when the pipette tip 14 is mounted on the tip mounting shaft 12. However, the circumferential shoulder 40 has sufficient structural integrity to maintain roundness of the circular cantilever sealing ring 100 so that an inside surface 104 of the annular wall 101 seals laterally against the sealing area 55 of the mounting shaft 12.

The circumferential shoulder 40 as shown in FIG. 5 is continuous around the circumference of the tip 14. The shoulder 40 in the exemplary embodiment is angular in cross section, however, it need not be angular. The circumferential shoulder 40 provides structural integrity that serves to separate and isolate the distortion of the collar 36 from circular cantilever sealing ring 100. As is best illustrated in FIG. 11, the collar 36 is distorted out-of-round when the mounting shaft 12 is fully inserted into the pipette tip 14. The circumferential shoulder 40 of the tip 14 isolates the circular cantilever sealing ring 100 from this distortion, thereby facilitating an effective lateral seal between the inside surface 104 of the annular wall 101 of the circular cantilever sealing ring 100 on pipette tip 14 and sealing region 55 (not shown in FIG. 11). the mounting shaft 12 around the entire circumference.

Referring again to FIG. 5, to accurately locate the mounting height of the tip 14 on the mounting shaft 12 when the tip 14 is fully mounted to the mounting shaft 12, the stop 34 on the mounting shaft 12 engages the top edge 102 of the annular wall 101 of the circular cantilever sealing ring 100. With multi-channel devices, this configuration ensures the same vertical mounting distance from tip to tip, which facilitates precise and consistent tip positioning during pipetting. When the tip 14 is in a relaxed state, the inside circumferential surface 104 of the annular wall 101 angles slightly inward as the annular wall 100 extends upward towards the collar opening 42. The slight inward slant provides a lateral interference fit between the inside surface 104 of the annular wall 101 and the cylindrical sealing region 55 of the mounting shaft 12 when the mounting shaft 12 is fully inserted. The annular wall 101 extends upward above the circumferential shoulder 40 such that there is a gap 106 between the annular wall 100 and the collar sidewall 36. The gap 106 enables the annular wall 100 to pivot outward laterally when the pipette mounting shaft 12 is inserted into the tip 14. The inside diameter immediately below the annular wall 101 is selected to have zero interference with the mounting shaft 14. Rather, the lateral interference fit of the annular wall 101 of the circular cantilever sealing ring 100 above the shoulder 40 of the tip 14 provides the sealing engagement of the tip 14 to the mounting shaft 12.

Referring to FIGS. 6, 9 and 10, the locking section 30 of the mounting shaft 12 has a central cylindrical aligning section 56 located immediately above and adjacent the stop 34. When the pipette tip 14 is mounted on the mounting shaft 12, the central cylindrical aligning section 56 on the mounting shaft 12 helps to maintain the tip 14 in a straight orientation, however there is preferably clearance between the collar sidewall 36 of tip 14 and central cylindrical aligning section 56 when the tip 14 is mounted on the mounting shaft 12. The diameter of the mounting shaft 12 decreases (e.g., steps down) at the stop 34 between the cylindrical section 56 above the stop 34 and the sealing section 55 below the stop 34. The reduction in shaft diameter at the stop 34 is generally commensurate with the reduction in diameter of the matching pipette tip 14 at its circumferential shelf 40. This reduction is preferably in the range of about 0.1 to 1.0 mm. It is not necessary that the cylindrical aligning section 56 and the stop 34 be continuous around the circumference of the mounting shaft 12 inasmuch as the purpose of these components is to provide secure, stable locking engagement of the pipette tip 14 on the mounting shaft 12 and not to provide a seal. In this regard, the configuration of the mounting shaft 12 in the exemplary embodiment is similar to that disclosed in the following above incorporated U.S. Pat. Nos. 7,662,343; 7,662,344; 8,277,757; 8,501,118; 8,877,513 and 9,333,500, which are owned by the assignee of the present application.

Above the cylindrical aligning section 56, the diameter of the mounting shaft 12 may reduce to provide additional clearance between the mounting shaft 12 and the collar of the pipette tip 14. Referring to FIG. 6, as mentioned, the top of the locking section 30 of the mounting shaft 12 includes two or more locking lobes 50 circumferentially spaced evenly around the mounting shaft 12, as well as corresponding recessed areas 58 spanning between the locking lobes 50. The lobes 50 include relatively gently sloping inclining ramps 60. The preferred slope of the inclining ramp 60 with respect to the vertical axis of the mounting shaft is between 10° and 20°. The lobes 50 angle outward as the inclining ramp 60 extends towards a peak portion 61 of the lobe 50. Each lobe 50 also includes a declining ramp 62 which slopes inward as the declining ramp 62 extends upward away from the peak portion 61. Preferably, the inward slope of the declining ramp 62 is the same as the outward slope of the inclining ramp 60, although such symmetry is not necessary. The peak portion 61 is preferably curved and has a radius of between 0.15 and 0.38 mm. At the peak portion 61, the lobes 50 preferably extend outward beyond the outer surface of the cylindrical aligning section 56, although the exact preferred dimensions will depend on the amount of taper of the collar 36 in the corresponding matching pipette tip as well as the tip wall thickness. It is preferred that the mounting shaft 12 be made of a material to reduce rough edges and reduce friction.

Preferably, the recessed portions 58 between the lobes 50 consume a substantial portion of the circumference of the mounting shaft 12 both at the peak portion 61 and along the declining ramp 62 where the locking ring 48 on the pipette tip 14 would normally engage when the mounting shaft 12 is fully inserted into the pipette tip 14. In accordance with the exemplary embodiment of the invention, the lobes 50 at the peak portions 61 consume less than 15% of the mounting shaft circumference. The narrow locking lobes 50 reduce friction associated with mounting and ejecting pipette tips 14. Note that the recesses 58 extend downward along the mounting shaft 12 below the height of the lobes 50 to accommodate inward distortion of the tip collar 36 when the tip is mounted to the mounting shaft 12.

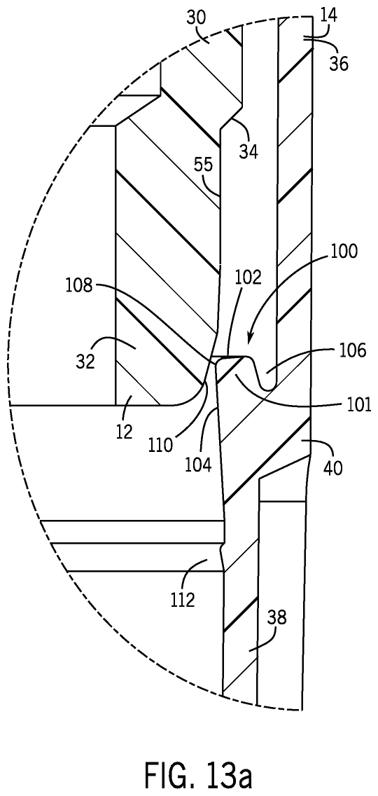

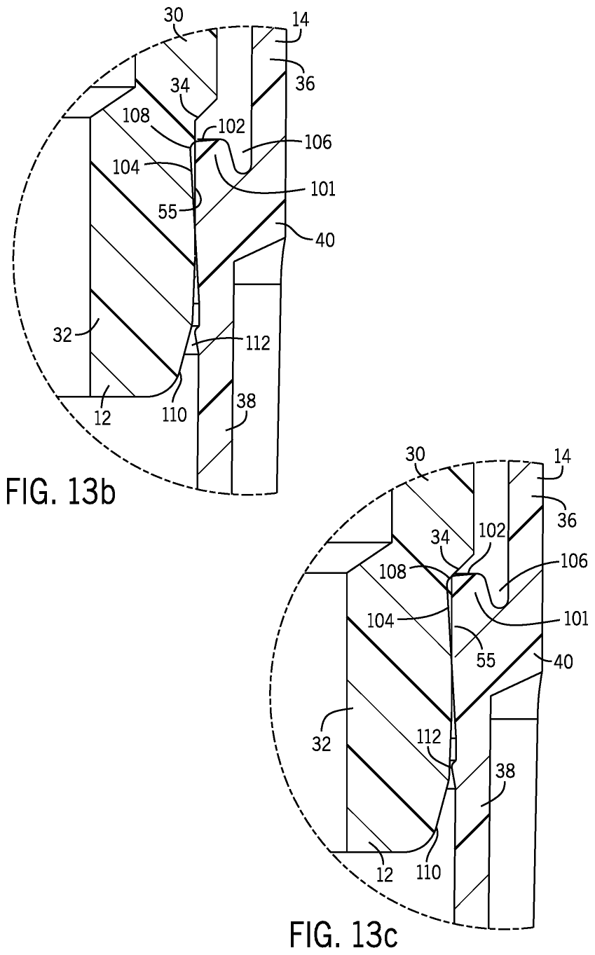

Referring now to FIGS. 13a-13c, as the mounting shaft 12 is pushed into the tip 14, the first point of contact is when the leading edge 110 of the mounting shaft 12 passes through the opening formed by the top edge 102 of the annular wall 101 of the circular cantilever sealing ring 100, FIG. 13a. The leading edge 110 of the mounting shaft 12 is tapered substantially to facilitate reliable insertion of the leading edge 110 through the upper edge 102 of the annular wall 101.

The corner between the top edge 102 and the inside surface 104 is rounded to also facilitate proper insertion. As the mounting shaft 12 continues the path of insertion, the inside surface 104 of the annular wall 100 is bent outward as the diameter of the mounting shaft 12 increases. FIG. 13b shows the lateral inside surface 104 engaging the sealing region 55 of the mounting shaft 12 to provide a lateral sealing engagement. The sealing region 55 on the mounting shaft 12 is desirably cylindrical such that the lateral seal is cylindrical and vertical. This configuration, with the cylindrical sealing region 55 on the mounting shaft 12, is particularly advantageous since the lateral cylindrical seal provides robust sealing and does so with relative low insertion force. In FIG. 13b, the annular wall 101 and its inside surface 104 have been drawn as though the annular wall 104 theoretically did not bend outward as the mounting shaft 12 is inserted. FIG. 13b as drawn illustrates the amount of interference between the inside surface 104 of the annular wall 101 and the cylindrical sealing region 55 on the mounting shaft 12. FIG. 13c is drawn in a similar fashion.

FIG. 13c shows the mounting shaft 12 fully inserted into pipette tip 14 with the circumferential stop 34 on the mounting shaft 12 contacting the top edge 102 the annular wall 101 of the circular cantilever sealing ring 100 on the tip 14. As mentioned, the stop 34 in the exemplary embodiment is angled such that it contacts the corner 108 between the inside surface 104 and the top edge 102 of the annular wall 101. The stop 34 is not intended to seal at this location and can optionally include one or more voids around its circumference to ensure that sealing does not take place against the stop 34. Having the stop 34 at an angle is advantageous because it accommodates manufacturing tolerances in the mounting shaft 12 or the pipette tip 14.

Reference number 114 in FIG. 10 identifies the threshold location of zero interference between the inside surface 104 of the annular wall 101 of the circular cantilever sealing ring 100 on the pipette tip 14 and the cylindrical sealing region 55 of the mounting shaft 12. The lateral interference seal occurs on the inside surface 104 above the threshold location 114 of zero interference and the corner 108. The vertical length of the interference is desirably 0.20 to 0.30 mm in this exemplary embodiment. The maximum interference is desirably 0.08 mm, which has been found to provide robust sealing even when normal machining and molding tolerances are taken into account. The annular wall 101 bends radially outward into the gap 106 to accommodate the interference between the cylindrical sealing region 55 on the mounting shaft 14 and the inside surface 104 of the annular wall 104. The height of the gap 106 in this exemplary embodiment is 0.30 mm, and its max width is 0.30 mm.

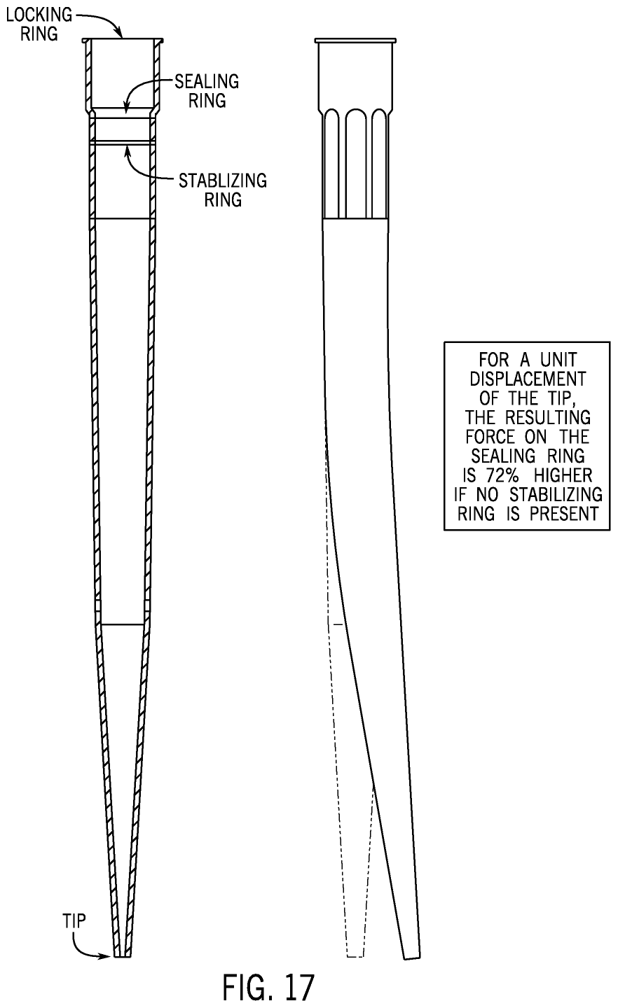

The diameter of mounting shaft 12 tapers slightly between the cylindrical sealing region 55 and the more aggressively tapered leading edge 110. At the same time, the diameter of the inside surface of the pipette tip 14 below the threshold location 114 of zero interference continues to expand slightly in order to ensure that there is clearance and very little friction below the threshold location 114. Still referring to FIG. 13c, just above the aggressively tapered leading edge 110, the mounting shaft 14 abuts a stabilizing ring 112 in the upper end of the barrel 38 of the pipette tip 14. The stabilizing ring 112 aligns the tip 14 on the mounting shaft 12 such that the circular cantilever sealing ring 100 does not need to align the tip 14, thereby improving both the symmetry of the interference fit at the lateral seal 104 and alignment of the tip opening 44 (FIG. 2). The structural modeling of a tip (FIG. 17) showed that the removal of the stabilizing ring 112 raises the force on the sealing ring 100 by 72%, increasing the risk of liquid leaking (for example, during touch-off). This was empirically confirmed in experiments demonstrating that tips without a stabilizing ring 112 consistently leaked when a lateral displacement was applied versus tips with a stabilizing ring given that equivalent lateral displacement which did not leak.

Referring now to FIGS. 9 and 10, as the mounting shaft 12 is inserted into the tip 14, the inclining ramp 60 of the locking lobes 50 begin to engage the upper portion of the tip collar 36 just prior to the time that the circumferential stop 34 on the mounting shaft 12 contacts top edge 102 of the annular wall 101 of the circular cantilever sealing ring 100 on the tip 14. As the mounting shaft 12 is further inserted into the tip, the inclining ramp 60 on the lobes 50 push against the locking ring 48 on the tip collar 36 to gently flex the collar 36 and distort it out-of-round. The recessed areas 58 on the mounting shaft 12 provide ample clearance for the straightening of the collar 36 that occurs between the lobes 50. The intent is for the lobes 50 on the mounting shaft 12 to flex the collar out-of-round rather than to stretch the collar 36 on the mounting shaft 12. When the mounting shaft 12 is fully inserted into the pipette tip collar 36, see FIG. 10, the stop 34 on the mounting shaft 12 abuts the corner 108 of the annular wall 100 of the circular cantilever sealing ring 100 on the pipette tip 14, thus preventing further movement of the shaft 12 into the tip 14. At the point of engagement, the locking ring 48 on the inside surface of the tip collar 36 more or less simultaneously slides over the peak portion 61 of the lobes 50 on the mounting shaft 12 such that the locking ring 48 engages the declining ramp portion 62 of the lobe 50. Thus, the pipette tip 14 is securely locked into place on the mounting shaft 12 with there being a positive engagement between the stop 34 on the mounting shaft 12 and the corner 108 of the annular wall 104 on the pipette tip 14 on one hand; and, the declining ramp portion 62 of the lobes 50 on the mounting shaft 12 and the underside of the locking ring 48 on the tip collar 36 on the other hand. As mentioned previously, the stabilizing ring 112 in the top of tip barrel 38 aligns the tip 14 below the circular cantilever sealing ring 100, whereas the interaction between the lobes 50 on the mounting shaft 12 and the locking ring 48 on the tip collar 36 provide alignment above the circular cantilever sealing ring 100.

FIG. 11 shows a cross-sectional view looking down on the tip collar 36 being locked onto the mounting shaft 12 over the lobes 50. The collar 36 is flexed and distorted to an out-of-round condition. Note that phantom line 70 indicates the outside surface of the collar opening in its relaxed round state before being mounted on the mounting shaft 12. The phantom line 72 indicates the position of the inside surface of the locking ring 48 on the collar 36 in its relaxed round state before being mounted over the lobes 50 on the mounting shaft 12. While the mounted collar 36 is flexed and distorted out-of-round, the circumferential shoulder 40 and the circular cantilever sealing ring 100 remain circular due to the structural integrity circumferential shoulder 40.

By flexing and distorting the tip collar 36 rather than stretching the collar 36 in order to mount the tip 14, the required insertion force is less compared to tip mounting configurations that require tight interference fits or stretching of the tip collar. In addition, as mentioned above, the bending of the annular wall 101 of the circular cantilever sealing ring 100 when providing the lateral interference seal, further reduces required insertion forces compared to stretching the tip or crushing an annular seal on the pipette tip. Still, the user receives definite tactile feedback that full engagement has occurred when the stop 34 engages the circular cantilever sealing ring 100 on the tip 14, the locking ring 48 on the tip 14 slides over the lobes 50 and the mounting shaft 12 abuts the stabilizing ring 112. The locking engagement is robust and prevents unintentional de-mounting of the tip when a side force is applied to the tip, such as during a touching off procedure. And, the seal is robust even though low insertion force is required.

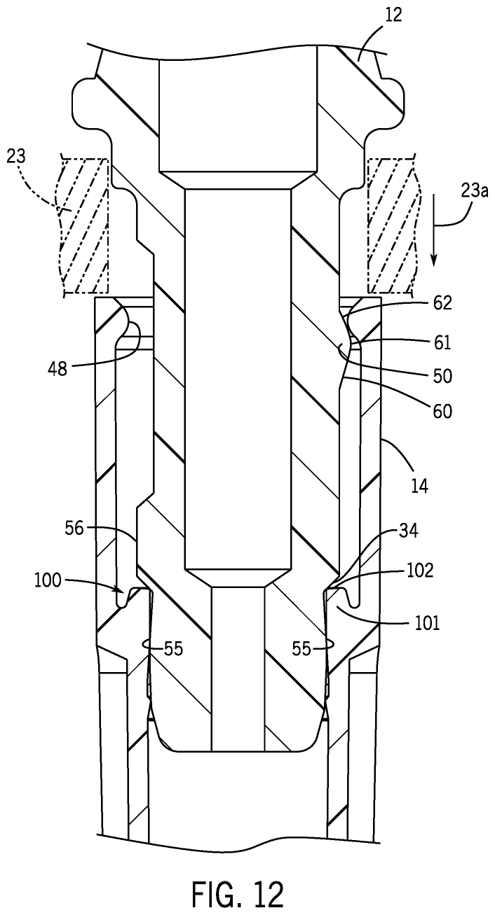

Another advantage of the invention is lower ejection forces. Referring to FIG. 12, a stripping plate 23 is shown moving downward (arrow 23a) to push on the top of the collar 36 to eject the tip 14, as is common in the art. Once the locking ring 48 clears the peak portion 61 on the lobes 50, energy stored in the distorted collar 36 is released and facilitates efficient ejection of the tip 14 from the mounting shaft 12. The use of lobes 50 with a gently sloped declining ramp 62 and a curved peak portion 61 connecting an inclining ramp 60 to the declining ramp 62 reduces the required ejection force yet provides ample lateral stability. Further, since the configuration (i.e., use of a stop 34) prevents over insertion of the mounting shaft 12 into the tip 14, the required ejection force is consistent and not dependent on how deep the mounting shaft 12 was inserted as in some prior art pipette tips. Additionally, releasing the tip 14 from the circular cantilever sealing ring 100 takes less force than from prior art annular sealing rings that rely on stretching the tip or crushing the sealing ring.

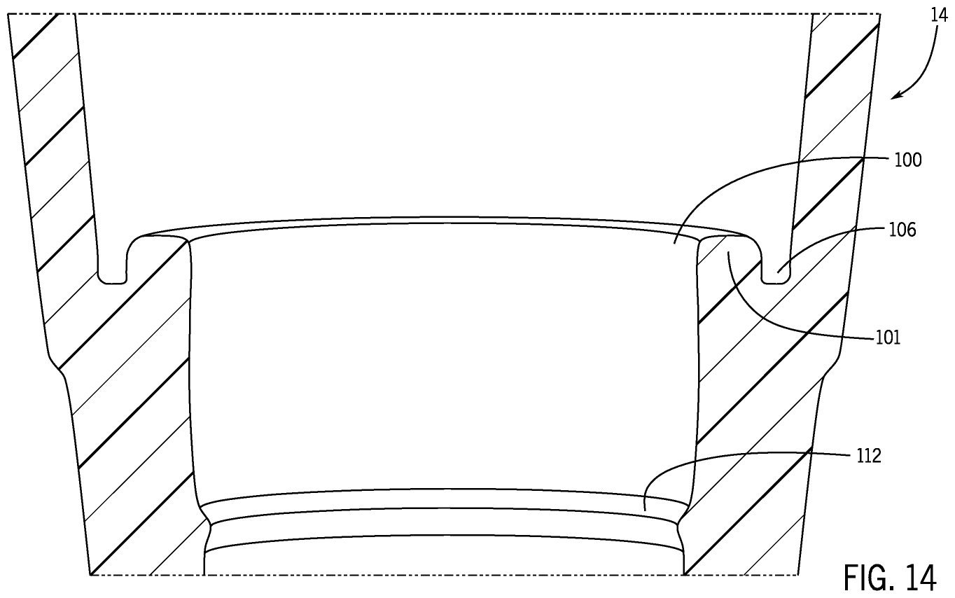

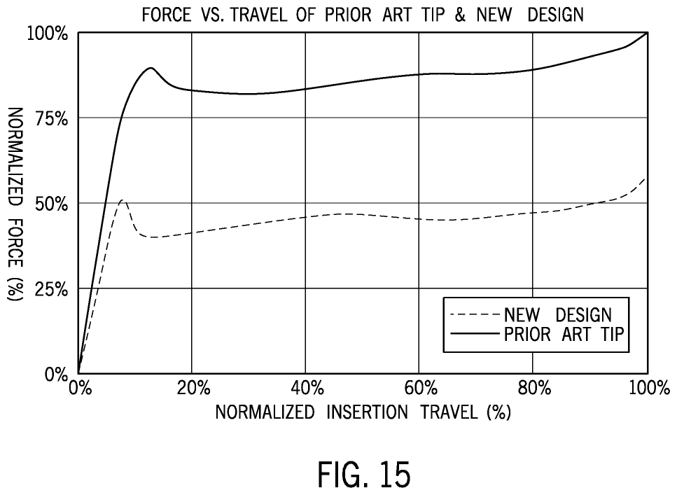

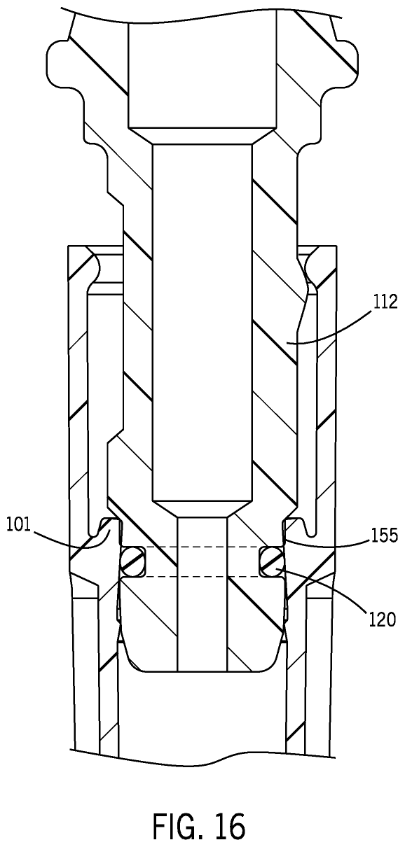

The disposable pipette tips 14 are typically made by injection molding virgin polypropylene. FIG. 14 is shows a cross section of a portion of a polypropylene pipette tip 14 molded to have a configuration in accordance with the exemplary embodiment of the invention, described in FIGS. 1-13. FIG. 14 shows the cross section of the circular cantilever sealing ring 100 and the stabilizing ring 112. The pipette tip is for a 125 μl fitting. The minimum diameter of the inside surface 104 of the annular wall 101 of the circular cantilever sealing ring 100 is 2.58 mm+/−a molding tolerance. The height of the gap 106 around the annular wall 101 is 0.30 mm+/−a molding tolerance. The inside diameter of the stabilizing ring 112 is 2.58 mm+/−a molding tolerance. FIG. 15 contains data that compares insertion forces for tips illustrated in the photograph of FIG. 14 and constructed in accordance with the invention to insertion forces for tips constructed according to assignee's previous design in which sealing occurred using a sealing ring in the barrel of the tip. The data in FIG. 15 shows that the maximum force needed to insert the mounting shaft 12 into a pipette tip 14 constructed in accordance with the invention is substantially less than the maximum force needed to insert the mounting shaft 12 into a pipette tip 14 that is similarly sized (125 μl) and constructed in accordance with assignee's previous design. The y-axis in FIG. 15 plots insertion force as a percentage of the maximum insertion force of the previous design, and the x-axis plots insertion distance as a percentage of the end of the insertion process. In both cases, the required insertion force has a local peak as the locking ring 48 on the pipette tip 14 is distorted when the inclining ramps 60 on the lobes 50 of mounting shaft 12 are being pushed against the locking ring 48. The local maximum for assignee's former design is about 89%, whereas the local maximum for tips constructed in accordance with the invention is about 50%. As the mounting shaft 12 is further inserted, the insertion force drops slightly as the peak of the lobes 50 clear the locking ring 48 on the tip collar. Then, the insertion force in both cases trends upward slightly until the stop 34 on the mounting shaft 12 reaches its end of travel. The assignee's previous tips require approximately 100% at the end of the insertion process, whereas tips constructed in accordance with the invention require about 58% at the end of the insertion process. The reduction in the insertion forces is attributable to the use of the circular cantilever sealing ring 100 instead of a sealing ring in the barrel that requires the barrel to stretch or that the sealing ring be crushed.

The data in FIG. 15 is for a 125 μl pipette tip, but the invention is useful for pipette tips having collars with different sizes. For tips having larger tip collars, it may be desirable to modify the design as illustrated in FIG. 16 to incorporate an O-ring 120 in the sealing region 155 of the mounting shaft 112. The configuration of the circular cantilevered sealing ring 100 is conceptually unchanged, however, the O-ring 120 engages the inside surface of the annular wall 101 instead of a cylindrical portion of the mounting shaft 112. Despite the ability to operate effectively with a mounting shaft 112 having an O-ring 120, the invention reduces the insertion forces significantly and it is contemplated that the invention will eliminate the need to use O-rings 120 in most practical circumstances.

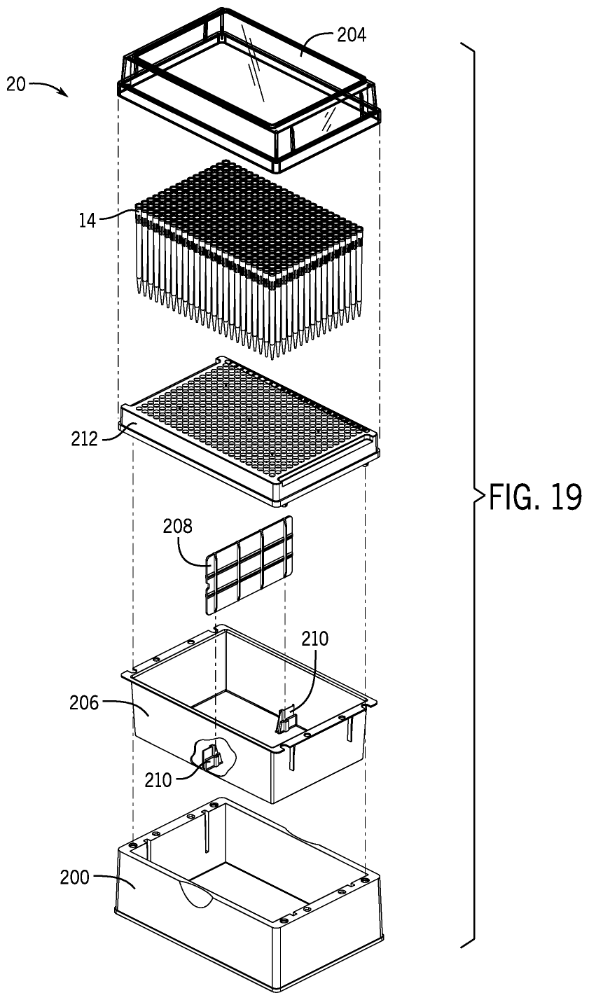

FIG. 18 shows a pipette tip rack system 20 configured to withstand the rigors of robotic liquid handling systems constructed in accordance with a first exemplary embodiment of the invention. The pipette tip rack system 20 has a reusable base 200 and a refill pack 202 containing an array of 384 pipette tips 14. In FIG. 18, the refill pack 202 is set in the reusable base 200 with the transparent cover 204 still on. FIG. 19 is an assembly view illustrating components of the refill pack 202, including a disposable tip receptacle or liner 206, a removable vertical support rib 208, a plastic tip insert 212, an array of 384 pipette tips 14 and a transparent cover 204. FIG. 19 also shows the reusable base 200.

The disposable tip receptacle 206 defines a well for storing the barrel portions of the pipette tips 14 and has two vertical rib mounts 210 that hold the vertical support rib 208 upright so that it supports the plastic tip insert 212. The support by the vertical support rib 208 is provided to keep the plastic tip insert 212 on plane when mounting the array of 384 tips 14 simultaneously to an array of mounting shafts on a pipetting head. The plastic tip insert 212 spans over the well in the disposable tip receptacle 206. The peripheral skirt of the plastic tip insert 212 is supported by the sidewalls of the disposable tip receptacle 206 for packaging purposes. The array of 384 holes in the plastic tip insert 212 hold the array of pipette tips 14 with the centerline of the respective holes spaced apart from one another at a spacing of 4.5 mm in accordance with SBS industry standards. The pipette tips 14 are held substantially vertically with collars of the respective pipette tips facing upward to facilitate mounting of the pipette tips onto an array of pipette mounting shafts 12 on a robotic liquid handling system, e.g. the system 10, although the tips 14 could be used on a handheld pipette too. The transparent cover 204 covers the plastic tip insert 212 and the collars of pipette tips 14 held in place by the plastic tip insert 212 for packaging, shipping and storage purposes. The use of the cover 204 in combination with the disposable tip receptacle 206 and plastic tip insert 212 is effective and convenient to use as packaging for sterile pipette tips but can be used for non-sterile pipette tips as well.

After the tips 14 are mounted, the plastic tip insert 212 can be removed from the disposable tip receptacle 206, and the vertical support rib 208 can also be removable from the vertical rib mounts 210 in the disposable tip receptacle 206. The plastic tip inserts 212 are configured to be stackable and the disposable tip receptacles 206 are configured to be nestable, thereby reducing waste storage needs in the laboratory.

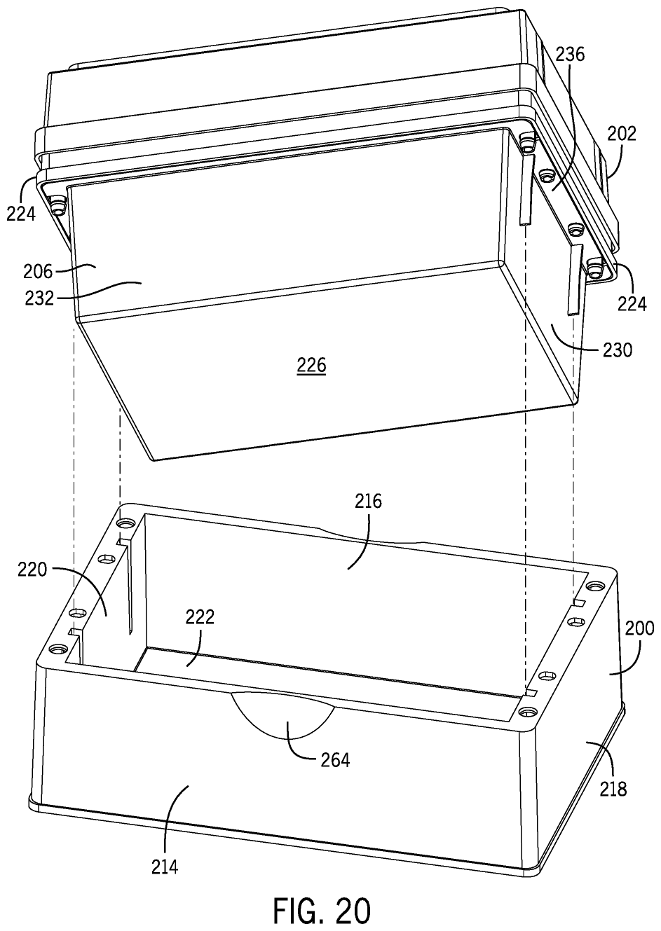

Referring to FIG. 20, the reusable base 200 comprises a bottom wall 222, lateral sidewalls 218, 220, a front sidewall 214 and a back sidewall 216. FIG. 20 shows the refill pack 202 being is set into the reusable base 200 such that the top of the sidewalls 214, 216, 218, 220 of the reusable base 200 supports a peripheral skirt 224 of the plastic tip insert 212 and provides primary support when the pipette tips 14 are being mounted onto of an array pipette mounting shafts 12. The bottom wall 222 of the base also supports the vertical support rib 208 (hidden in FIG. 20) inside the well of the disposable tip receptacle 206, which in turn supports the midpoint of the bottom surface of the plastic tip insert 212 when the pipette tips 14 are being mounted onto the array pipette mounting shafts 12. The disposable tip receptacle 206 has a bottom wall 226, lateral sidewalls 228, 230, a front sidewall 232 and a back sidewall 234. It also has a peripheral rim 236 that extends laterally from the upper rim of the receptacle sidewalls 228, 230, 232, 234. The dimensions of the disposable tip receptacle 206 are selected so that the bottom wall 226 of the tip receptacle 206 rests on the bottom wall 222 of the reusable base 200 when it is placed into the reusable base. The finger cutouts 264 on the front 214 and rear 216 sidewalls of the reusable base 200 make it easier to remove the refill pack 202 from the reusable base 200 after use.

Referring to FIGS. 21 through 23, the tip receptacle 206, also known as a liner, is preferably made from injection molded, clear polypropylene. The support ribs mount 210 each include a short wall 210a and a tall wall 210b. The staggered heights make it easier to install the vertical support rib 208. The short wall 210a and the tall wall 210b each extend upward from the bottom wall 226 and inward from the adjacent sidewall 232, 234 respectively. The short wall 210a and the tall wall 210b are spaced apart to form a mounting slot for the vertical support rib 208. The short wall 210a and the tall wall 210b also each have a vertical indentation which receives a respective vertical ridge on the removable vertical support rib 208. This interaction between the vertical indentations and the vertical ridge on vertical support rib 208 helps to stabilize the vertical support rib 208, especially when the rib 208 is under a full loading force. The inside edges of both the short walls 210a and tall walls 210b are inclined.

The sidewalls 228, 230, 232 and 234 angle outward, e.g. about 5 degrees, as the sidewalls extend upward from the bottom 226. The lateral sidewalls 228, 230 each contain vertical stacking ribs 238, which facilitate proper nesting of the used tip receptacles 206 after use, and also help to align the refill pack 202 as it is being set into the reusable base 200. The vertical stacking ribs 238 in this embodiment extend down from the peripheral rim 236 along the respective sidewall 228, 230 for about one half of the height of the tip receptacle 206. The peripheral rim 236 on the tip receptacle 206 is wider above the lateral sidewalls 228, 230 than above the front 232 and back 234 sidewalls. The peripheral rim 236 includes two snap-fit holes 240 on each lateral side and two slots 242 for guideposts on each lateral side. The snap-fit holes 240 are configured to snap onto snap fittings on the plastic tip insert 212 to hold the tip receptacle 206 together with the refill pack 202 during shipping, storage and use. However, the snap connection is relatively easy to dismantle by a lab worker after the refill pack is used and the packaging is broken down for storage prior to disposal or recycling.

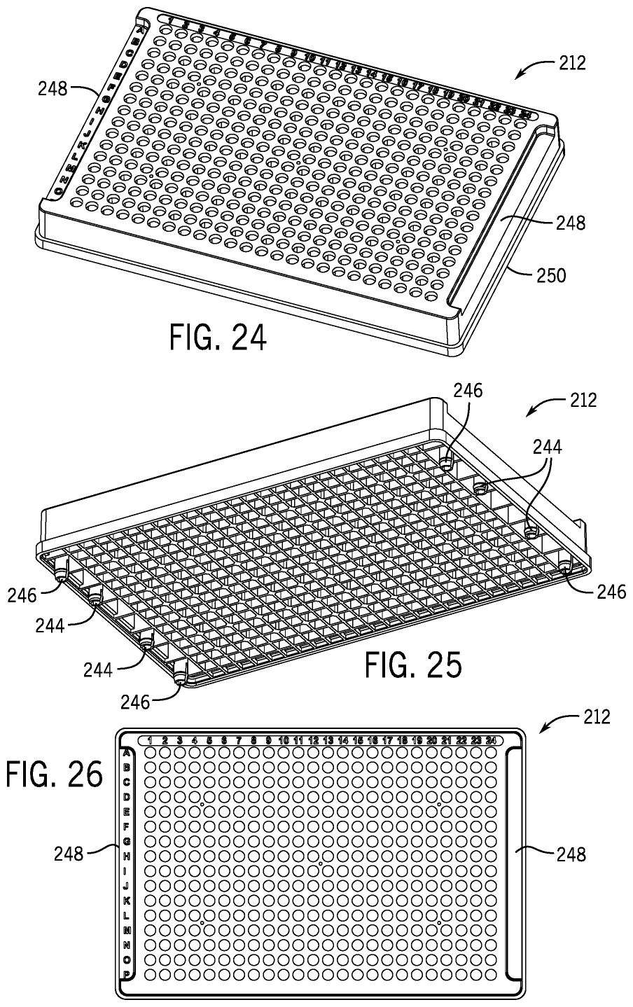

Referring to FIGS. 24 through 26, the plastic tip insert 212 is preferably made from injection molded polypropylene that has been color coded to represent the size and configuration of mounting shaft 12 that the pipette tips 14 are configured to be mounted. The plastic tip insert 212 in FIGS. 24-26 has an array of 384 holes to hold pipette tips 14, which are arranged in 16 rows labelled A-P and 24 columns labelled 1-24, as is standard in the industry. The centerline spacing is 4.5 mm which is also standard in the industry and in accordance with SBS standards. Referring to FIG. 25 in particular, extending from the bottom of the plastic tip insert 212 are four snap fittings 244 and four guideposts 246. The snap fittings 244 are formed with a vertical slot that enables the sides of the fittings to be pressed together. The snap fittings 244 also have a groove in which the peripheral rim 236 of the tip receptacle 206 sits when the plastic tip insert 212 is connected to the tip receptacle 206. The snap fittings 244 pass through the snap fitting holes 240 in the peripheral rim 236 on each lateral side of the tip receptacle 206. The snap fit is sufficiently rigorous to maintain the connection during shipping, storage and use but the snap fittings 244 and the fit through the holes 240 on the tip receptacle 206 are chosen to enable relatively easy dismantling of the plastic tip insert 212 from the tip receptacle 240 after use. The guideposts 246 are located closer to the corners of the plastic tip insert 212 and are longer than the snap fittings 244. The guideposts 246 have a tapered distal end and are intended to be inserted into guide holes on the reusable base 200. The slots 242 in the peripheral rim 236 of the tip receptacle 206 provide clearance for the guideposts 246 but do not interfere with the dismantling of the plastic tip insert 212 from the tip receptacle 206. The purpose of the guideposts 246 is to precisely locate the plastic tip insert 212, and the pipette tips 14, when the refill pack 202 is set into the reusable base 200. The outer skirt 250 around the periphery of the plastic tip insert 212 is configured to sit on top the sidewalls of the reusable base 200 when the refill pack 202 is placed in the reusable base 20. The plastic tip inserts 212 are also configured to be stackable once dismantled from the tip receptacle 206. Longitudinal indentations 248 along each lateral side of the plastic tip insert 212 provide clearance for the guideposts 246 and the snap fittings 244 when the plastic tip inserts 212 are stacked, and the guideposts 246 residing at the ends of the longitudinal indentations 248 help to stabilize the stack as well.

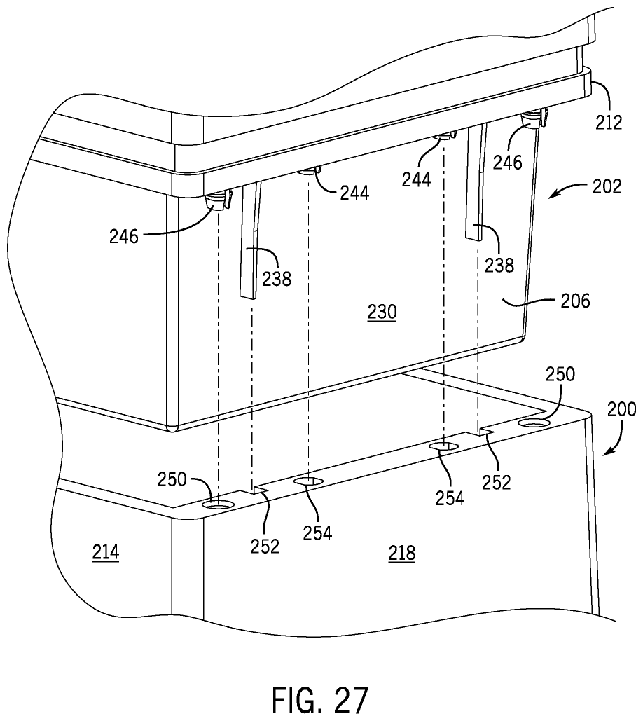

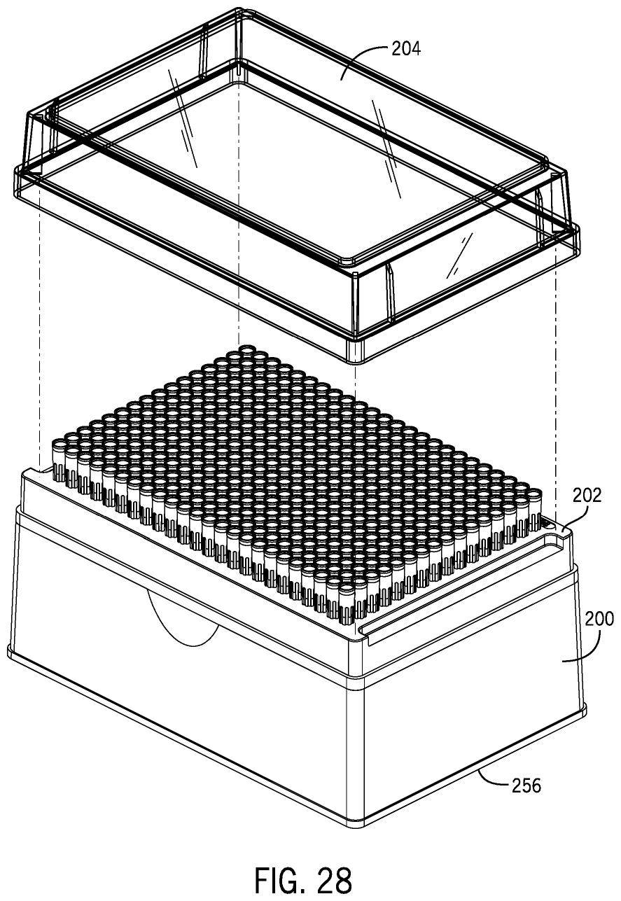

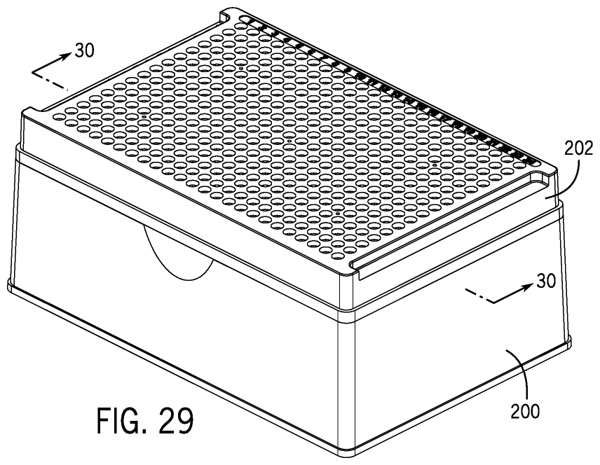

FIG. 27 shows the refill pack 202 being inserted into the reusable base 200, and in particular the top of one of the lateral sidewall 218. The top of the lateral sidewall 218 on both sides includes guide holes 250 for the guideposts 246 extending down from the plastic tip insert, vertical slots 252 for the vertical stacking ribs 238 on the tip receptacle 206, and fitting holes 254 for the snap fittings 244 attaching the tip receptacle 206 to the plastic tip insert 212. The guide holes 250 desirably have a enlarged tapered opening to help align the guideposts and the refill pack 202 as it is being set into the reusable base 200. The vertical ribs 238 are set into the slots 252 first, and the slots 252 have ample width to make the initial alignment of the insertion relatively easy, and then the guideposts 246 with the tapered distal ends and enter the guide holes 250 with the tapered opening to guide the refill pack 202 to a precise x/y position relative to the reusable base 200. The openings 254 provide clearance for the snap fittings 244. When the tips 14 are loaded, the guideposts 246 bear lateral forces and hold the plastic tip insert 212 in alignment with the reusable base 200. FIG. 28 shows the refill pack 202 set in the reusable base 200 with the cover 204 removed to expose the pipette tips 14 for loading onto an array of mounting shafts 12. The outer skirt 256 of the reusable base 200 have dimensions configured to match the dimensions of the nest 21 on the liquid handling equipment, e.g. preferably SBS dimensions, so that the array of pipette tips 14 can be located precisely according to SBS standards and ready for loading.

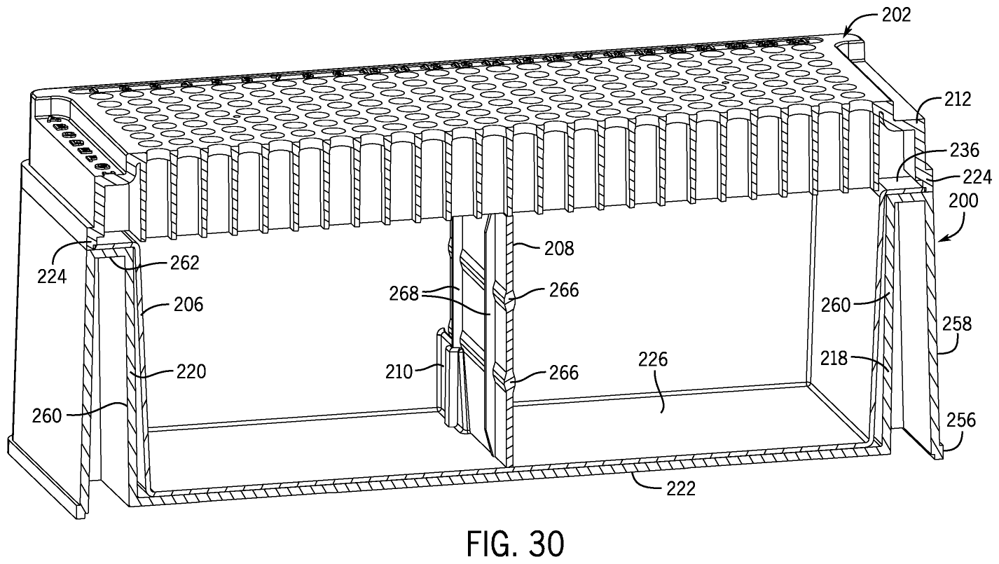

FIG. 29 shows the refill pack 202 and the reusable base 200 after the tips have been loaded. FIG. 30 is a cross section showing how the plastic tip insert 212 is supported while the tips are being loaded. The refill pack 202 is set in the reusable base 200 such that the sidewalls 214, 216, 218, 220 (see FIG. 20) of the reusable base 200 support the peripheral skirt 224 of the plastic tip insert 212 when the pipette tips 14 are being mounted onto the array of pipette mounting shafts. The sidewalls 214, 216, 218, 220 of the reusable base are constructed to withstand the cumulative loading force of 384 tips, and as can be seen in FIG. 30 have an outer wall 258 and an inner wall 260 connected at their top with a planar edge 262. The reusable base 200 is desirably molded from opaque polycarbonate. The bottom wall 226 of the reusable base 200 supports the vertical support rib 208 and in turn the bottom surface of the plastic tip insert 212.

The vertical support rib 208 keeps the plastic tip insert 212 from bowing under the cumulative loading pressure. It is desirably located equidistant from the lateral sidewalls of the tip receptacle 228, 230 and also equidistant between the lateral sidewalls 218, 220 of the reusable base 200 when the refill pack 202 is set in the base 200. The vertical support rib 208 is located in the well of the tip receptacle 206, and is removably placed in the vertical rib mounts 210 that are in the well of the tip receptacle 206. The vertical support rib 208 extends upward from the bottom wall 226 of the tip receptacle 206 to a bottom surface of the plastic tip insert 212. The bottom wall 226 of the tip receptacle 206 sits on the bottom wall 222 of the reusable base 200 and the bottom wall of the reusable base 200 sits on the nest surface of the liquid handling equipment. Accordingly, the vertical support rib 208 should provide consistent support as long as the load is not too much to deform or tilt the vertical support rib 208. As can be see in FIG. 30 as well as other figures, the vertical support rib 208 has strengthening ridges 266, 268. The vertical strengthening ridges 268 extend outward from the support rib 208 father than the horizontal strengthening ridges 266 and are placed so as to not interfere with the placement of pipette tips in the SBS positioning format. Some of the vertical strengthening ridges 268 fit into indentations in the rib mounts 210 and help to secure the position of the vertical support rib 208 in the tip receptacle 206.

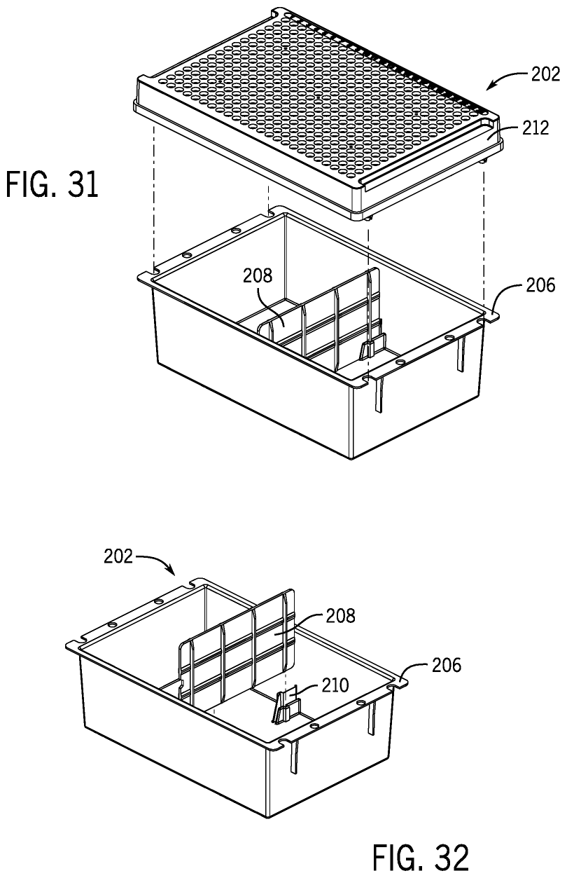

FIGS. 31 and 32 show the refill pack 202 being dismantled after use. In FIG. 31, the plastic tip insert 212 is removed from the tip receptable 206 by separating the snap fittings 244 from the tip receptacle 206. In FIG. 31, the vertical support rib 208 is shown being removed from the mounts 210 in the well of the tip receptacle 206. The vertical support rib 208 can be placed flat in the well of the tip receptacle 206 after it is removed from the mounts in order to facilitate stacking and nesting of used tip receptacles.

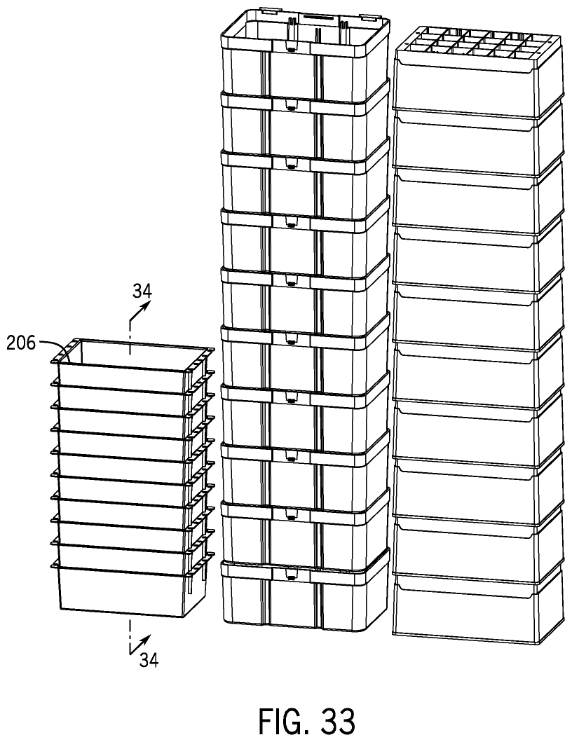

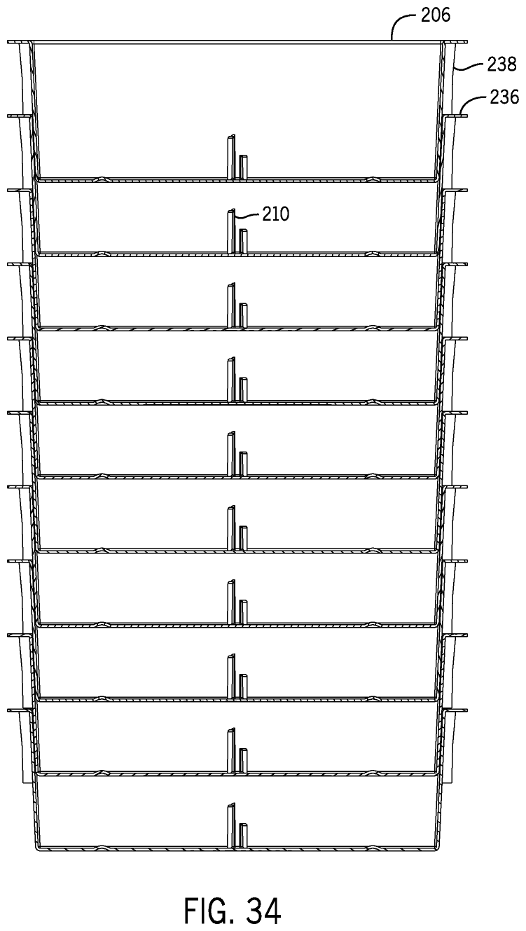

FIG. 33 shows a stack of nested tip receptacles 206 compared to stacks of prior art tip racks that are used for automated liquid handling applications. The dismantled disposable tip receptacles 206 save considerable space when storing prior to disposal or recycling. FIG. 34 shows a cross section of the stack of tip receptacles 206 and in particular the shows the stacking ribs 238 supporting the stacked tip receptacle 206 on the peripheral rim 236 of the tip receptacle 206 on which it is stacked. The stacking ribs 238 ensure that the mounts do not interfere with making a stable stack.

FIGS. 35 through 45 show a pipette tip rack system 301 configured to withstand the rigors of robotic liquid handling systems constructed in accordance with a second exemplary embodiment of the invention. The pipette tip rack system 301 is similar in many regards to that described in FIGS. 18 through 34, except that it is configured to hold an array of 96 pipette tips, instead of 384 tips, and is taller so that it can accommodate pipette tips 14 that are longer than that shown in connection with FIGS. 18 through 34. The following description focused on the differences between the two embodiments.

Referring to FIG. 35, the pipette tip rack system 301 has a two-part reusable base 300. The bottom part 300a is substantially identical to base 200 in the previous embodiment. The top part 300b of the reusable base 300 is stacked on the bottom part 300a as shown. The two-part construction enables the use bottom part 300a to be used for short refill packs 202 or, when the part is used, for the tall refill packs 302. The reusable base 300 does not need to be made in two parts to implement other aspects of the invention.

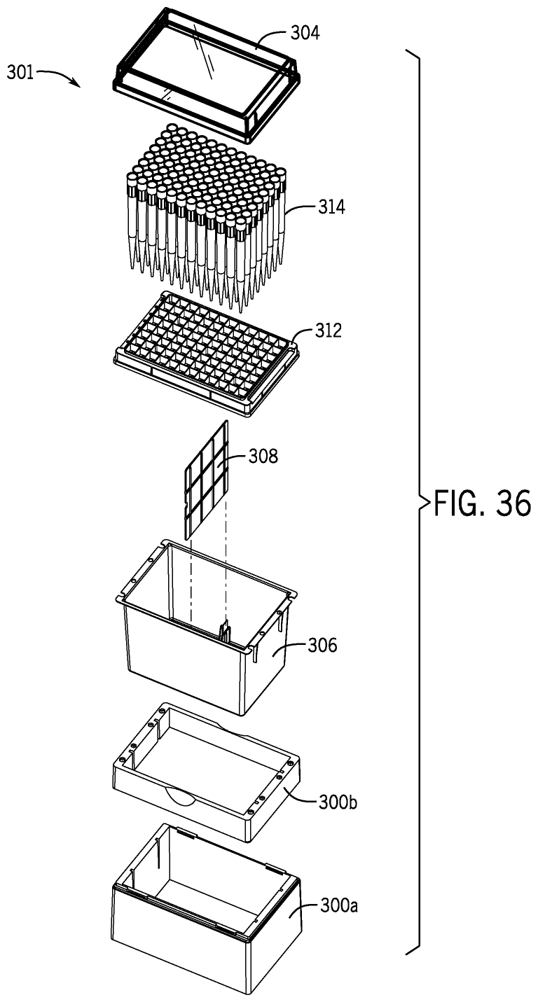

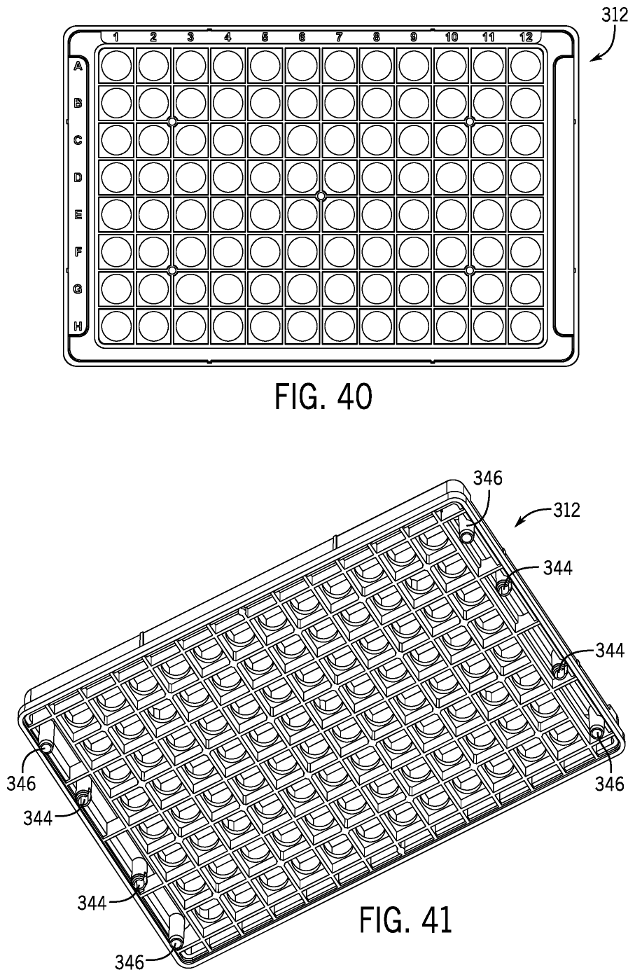

FIG. 36 shows the parts of the tip rack system 301 disassembled, similar to FIG. 19 for the short tip rack system 20. Aside from the plastic tip insert being for 96 tips and the reusable base 300a, 300b being in two parts, the system is similar to that described in connection with FIG. 19 except that the tip receptacle 306 and vertical support rib 308 are taller. The transparent cover 304 is desirably the same as the transparent cover 204 in the embodiment described in connection with FIG. 19. FIGS. 37 through 39 show the taller tip receptacle 306. It is similar to the previous embodiment 206, except its overall height is increased as is the height of the mounts 210, and the stacking ribs 338 are longer. FIGS. 40 and 41 show the 96 plastic tip insert 312 in which there are 8 rows (A-H) and 12 columns (1-12) of holes to hold pipette tips 14. The other features of the plastic tip insert 312 shown in FIGS. 40 and 41 are similar to those in the previous embodiment including the guideposts 346 and the snap fittings 344.

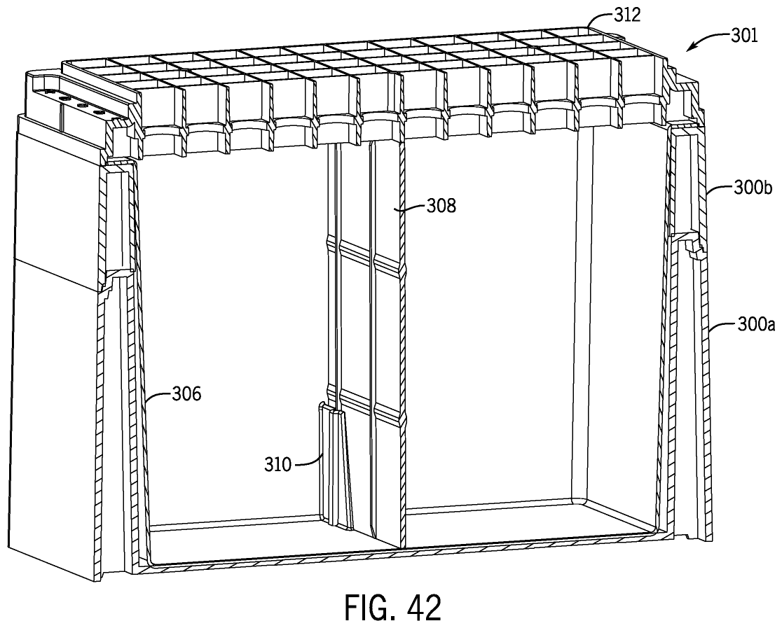

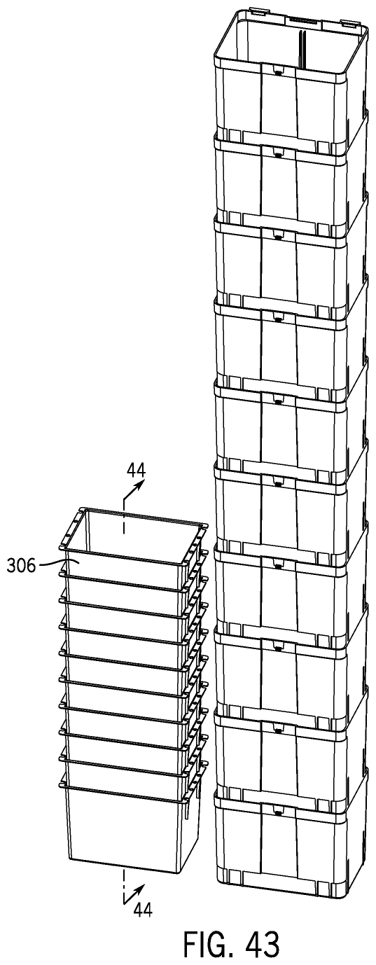

FIG. 42 is a cross section illustrating the load bearing components in the tall tip rack system 301. The plastic tip insert 312 is supported in a similar fashion to that described for the short rack system 20. FIG. 43 shows

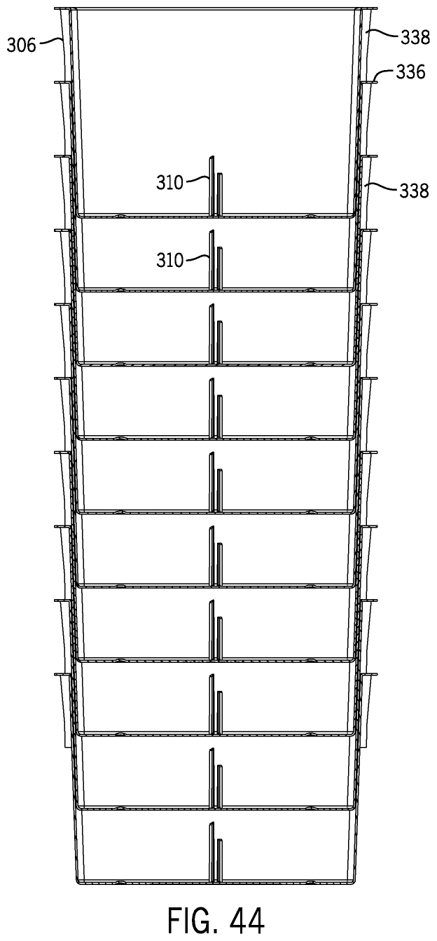

FIG. 43 shows a stack of the tall tip receptacles 306 compared to stacks of prior art tall tip racks that are used for automated liquid handling applications. The dismantled disposable tip receptacles 306 save considerable space when storing prior to disposal or recycling. FIG. 44 shows a cross section of the stack of the tall tip receptacles 306 and in particular the shows the stacking ribs 338 supporting the stacked tip receptacle 306 on the peripheral rim 336 of the tip receptacle 306 on which it is stacked. The stacking ribs 338 ensure that the mounts 310 do not interfere with making a stable stack.

It should be understood by those skilled in the art that while exemplary embodiments of the invention have been described in connection with the drawings, various aspects and features of the invention can be implemented in other forms.

What is claimed is:

1. A pipette tip rack system for robotic liquid handling systems including a reusable base and a refill pack containing an array of pipette tips, wherein the refill pack comprises:
a tip receptacle with a bottom wall, lateral sidewalls, a front sidewall and a back sidewall, wherein the tip receptacle defines a well for storing the barrel portions of pipette tips and has one or more vertical rib mounts;
a plastic tip insert spanning over the well and having a peripheral skirt supported by the sidewalls of the tip receptacle for packaging purposes, the plastic tip insert having an array of holes for holding an array of pipette tips with the centerline of the respective holes spaced apart from one another at a spacing of 4.5 mm or 9 mm, such that the pipette tips are held substantially vertically with collars of the respective pipette tips facing upward to facilitate mounting of the pipette tips onto an array of pipette mounting shafts on a robotic liquid handling system, said plastic tip insert being removably attached to the tip receptacle;
a removable cover that covers the plastic tip insert and the collars of pipette tips held in place by the plastic tip insert; and
a vertical support rib that is set in the one or more vertical rib mounts and extends upward from the bottom wall of the tip receptacle to a bottom surface of the plastic tip insert, said vertical support rib being removable from the one or more vertical rib mounts and from the tip receptacle;
and
the reusable base comprises a bottom wall, lateral sidewalls, a front sidewall and a back sidewall, wherein the refill pack is set in the reusable base such that the sidewalls of the base support the peripheral skirt of the plastic tip insert when pipette tips are being mounted onto of an array pipette mounting shafts on the robotic liquid handling system, and the bottom wall of the base supports the vertical support rib and the bottom surface of the plastic tip insert when pipette tips are being mounted onto the array pipette mounting shafts on the robotic liquid handling system.

2. The pipette tip rack system for robotic liquid handling systems as recited in claim 1 wherein the tip receptacle includes two vertical rib mounts with one integral with the bottom wall and the front sidewall and the other integral with the bottom wall and the rear sidewall, the vertical rib mounts being positioned and configured to hold the vertical rib support equidistant from the lateral sidewalls of the tip receptacle.

3. The pipette tip rack system for robotic liquid handling systems as recited in claim 1 wherein the tip receptacle has a peripheral horizontal rim extending outward from a top of the sidewalls, the peripheral rim including at least one snap-fit hole adjacent each lateral sidewall for a snap fitting on the plastic tip insert, the lateral sidewalls of the reusable base also have at least one snap-fit hole on top of each lateral sidewall for a snap fitting on the plastic tip insert and said plastic tip insert has at least one snap fitting extending downward from the peripheral skirt through the respective snap-fit hole in the peripheral rim of the tip receptacle, and into the snap-fit holes in the lateral sidewalls of the reusable base when the tip receptacle is loaded into the reusable base, wherein said snap fittings on the plastic tip insert can be pulled from the reusable base and from the tip receptacle after use to disassemble the plastic tip insert from the reusable base and from the tip receptacle.

4. The pipette tip rack system for robotic liquid handling systems as recited in claim 3 wherein the plastic tip insert further comprises guide post extending down from the peripheral skirt, and the peripheral rim of the tip receptacle includes holes or slots for the guideposts to pass, and the lateral sidewalls of the reusable base have guide holes on top of each lateral sidewall for the respective guide posts.

5. The pipette tip rack system for robotic liquid handling systems as recited in claim 1 wherein after use the plastic tip insert can be disassembled from the tip receptacle, said plastic tip inserts being stackable when disassembled from the tip receptacle, and the vertical support rib can be dissembled from the vertical rib mounts in the tip receptacle and said tip receptacles are stackable when disassembled from the plastic tip insert and the vertical support rib is dissembled from the vertical rib mounts.

6. The pipette tip rack system for robotic liquid handling systems as recited in claim 1 wherein an outer surface of opposed sidewalls of the tip receptacle has vertical nesting ridges extending from the peripheral rim partially down the respective sidewall, and the reusable base has slots for the vertical nesting ridges.

7. The pipette tip rack system for robotic liquid handling systems as recited in claim 2 wherein each vertical rib support comprises a pair of vertical walls.

8. The pipette tip rack system for robotic liquid handling systems as recited in claim 2 wherein the vertical support rib includes vertical and horizontal ridges, and each vertical rib mount is configured to receive at least one vertical ridge.

9. The pipette tip rack system for robotic liquid handling systems as recited in claim 1 wherein a bottom peripheral wall of the reusable base has outer nesting dimensions in accordance with SBS standards.

10. A refill pack containing an array of disposable pipette tips, wherein the refill pack comprises:
a tip receptacle with a bottom wall, lateral sidewalls, a front sidewall and a back sidewall, wherein the tip receptacle defines a well for storing the barrel portions of pipette tips and has one or more vertical rib mounts;
a plastic tip insert spanning over the well and having a peripheral skirt supported by the sidewalls of the tip receptacle for packaging purposes, the plastic tip insert having an array of holes for holding an array of pipette tips with the centerline of the respective holes spaced apart from one another at a spacing of 4.5 mm or 9 mm, such that the pipette tips are held substantially vertically with collars of the respective pipette tips facing upward to facilitate mounting of the pipette tips onto an array of pipette mounting shafts on a robotic liquid handling system, said plastic tip insert being removably attached to the tip receptacle;
a removable cover that covers the plastic tip insert and the collars of pipette tips held in place by the plastic tip insert; and
a vertical support rib that is set in the one or more vertical rib mounts and extends upward from the bottom wall of the tip receptacle to a bottom surface of the plastic tip insert, said vertical support rib being removable from the one or more vertical rib mounts and from the tip receptacle; and
an array of 96 or 384 disposable pipette tips contained in the plastic tip insert.

11. The refill pack containing an array of disposable pipette tips recited in claim 10, wherein the array of disposable pipette tips contains 384 disposable pipette tips and the loading force for each pipette tip is less than 8 Newtons.

12. The refill pack containing an array of disposable pipette tips recited in claim 10, wherein the array of disposable pipette tips contains 96 disposable pipette tips and the loading force for each pipette tip is less than 10 Newtons.

13. The refill pack containing an array of disposable pipette tips recited in claim 10, wherein said disposable pipette tips are configured for use with a robotic liquid handling system having an array of tip mounting shafts in which each tip mounting shaft includes an upper locking section having a stop, multiple outwardly extending lobes located above the stop and spaced circumferentially around the locking section of the mounting shaft, and recessed relief portions spanning circumferentially between the lobes and recessed relative to the lobes, and wherein each respective lobe has a peak spaced longitudinally above the stop on the mounting shaft by a predetermined distance, and each said tip mounting shaft including a sealing area located below the stop on the respective tip mounting shaft, further wherein each said disposable pipette tip comprises:
a barrel having a lower opening through which liquid is aspirated into the barrel and dispensed from the barrel, wherein the diameter of the lower opening is less than the diameter of the barrel at an upper end of the barrel;
a collar having a continuous inner surface with a circular circumference in its relaxed state, an upper opening for receiving the tip mounting shaft, and a lower end with an inside diameter that is larger than an inside diameter of the upper end of the barrel;
a circumferential tip shoulder connecting the lower end of the collar to the upper end of the barrel;
a circular cantilever sealing ring having an annular wall extending from the tip shoulder towards the collar opening for laterally engaging and sealing against the sealing area of the mounting shaft when the tip is fully mounted to the mounting shaft; and
said annular wall having a having a top edge that abuts the stop on the pipette mounting shaft when the tip is fully mounted to the mounting shaft;
wherein the collar of the disposable pipette tip is sufficiently flexible to distort outwardly at the lobes on the mounting shaft and inwardly at the recessed relief portions on the mounting shaft between the lobes when the pipette tip is mounted on the tip mounting shaft, and wherein the circumferential shoulder has sufficient structural integrity to maintain adequate roundness of the circular cantilever sealing ring so that the annular wall seals laterally against the sealing area of the mounting shaft.

14. The refill pack containing an array of disposable pipette tips recited in claim 13, wherein each disposable pipette tip further comprising means for engaging the respective locking lobes on the mounting shaft after the collar has been distorted outwardly at the lobes and inwardly at the recessed relief portions when the disposable pipette tip is mounted on the tip mounting shaft and the annular wall engages the stop on the mounting shaft.

15. The refill pack containing an array of disposable pipette tips recited in claim 14 wherein said means for engaging the pipette surfaces on the respective locking lobes comprising a locking ring extending inward from the continuous inner surface of the collar and around the entire circumference of the collar or substantially around the entire circumference of the collar and located at a rim of the upper opening of the collar and above the circumferential shoulder at a distance corresponding to the longitudinal distance between the stop on the mounting shaft and the peaks of the respective locking lobes on the mounting shaft.

16. The refill pack containing an array of disposable pipette tips recited in claim 13, wherein the circumferential shoulder of each disposable pipette tip reduces the internal bore diameter of the pipette tip by 0.1 to 1.0 mm.

17. The refill pack containing an array of disposable pipette tips recited in claim 13, wherein an inside surface of the annular wall of each disposable pipette tip slants inward in its relaxed state as it extends from the circumferential shoulder toward the opening in the collar.

18. The refill pack containing an array of disposable pipette tips recited in claim 17, wherein an inside surface of the annular wall of each disposable pipette tip forms an interference of 0.05 to 0.11 mm with a cylindrical sealing region on said mounting shaft.

19. The refill pack containing an array of disposable pipette tips recited in claim 13, wherein the slant of the inside surface of each disposable pipette tip continues as the surface extends downward to a threshold location for zero interference location and beyond the threshold location to provide ample clearance between the inside surface of the pipette tip and the mounting shaft below the threshold location.

20. The refill pack containing an array of disposable pipette tips recited in claim 19, wherein each disposable pipette tip further comprises a stabilizing ring located in an upper portion of the tip barrel which extends inward from the inside surface of the barrel.

21. The refill pack containing an array of disposable pipette tips recited in claim 13, wherein each disposable pipette tip further comprises a stabilizing ring located in an upper portion of the tip barrel.

22. The refill pack containing an array of disposable pipette tips recited in claim 13, wherein the circular cantilever sealing ring on each disposable pipette tip further comprises a circumferential gap above the circumferential shoulder between the annular wall of the circular cantilever sealing ring and the tip collar.

23. The refill pack containing an array of disposable pipette tips recited in claim 13, wherein the height of the circumferential gap on each disposable pipette tip is in the range of 0.28 to 0.38 mm.

24. The refill pack containing an array of disposable pipette tips recited in claim 13, said means on each disposable pipette tip for engaging the respective locking lobes on the mounting shaft comprises a circumferential locking ring at or near the opening of the collar of the respective disposable pipette tip.

25. The refill pack containing an array of disposable pipette tips recited in claim 24, wherein the circumferential locking ring on each disposable pipette tip includes a void.

26. The refill pack containing an array of disposable pipette tips recited in claim 10, wherein each disposable pipette tip is made of molded polypropylene.

27. A refill pack containing an array of disposable pipette tips wherein said disposable pipette tips are configured for use with a robotic liquid handling system having an array of tip mounting shafts in which each tip mounting shaft includes an upper locking section having a stop, multiple outwardly extending lobes located above the stop and spaced circumferentially around the locking section of the mounting shaft, and recessed relief portions spanning circumferentially between the lobes and recessed relative to the lobes, and wherein each respective lobe has a peak spaced longitudinally above the stop on the mounting shaft by a predetermined distance, and each said tip mounting shaft including a sealing area located below the stop on the respective tip mounting shaft, further wherein each said disposable pipette tip comprises:
a barrel having a lower opening through which liquid is aspirated into the barrel and dispensed from the barrel, wherein the diameter of the lower opening is less than the diameter of the barrel at an upper end of the barrel;
a collar having a continuous inner surface with a circular circumference in its relaxed state, an upper opening for receiving the tip mounting shaft, and a lower end with an inside diameter that is larger than an inside diameter of the upper end of the barrel;
a circumferential tip shoulder connecting the lower end of the collar to the upper end of the barrel;
a circular cantilever sealing ring having an annular wall extending from the tip shoulder towards the collar opening for laterally engaging and sealing against the sealing area of the mounting shaft when the tip is fully mounted to the mounting shaft; and
said annular wall having a having a top edge that abuts the stop on the pipette mounting shaft when the tip is fully mounted to the mounting shaft;
wherein the collar of the disposable pipette tip is sufficiently flexible to distort outwardly at the lobes on the mounting shaft and inwardly at the recessed relief portions on the mounting shaft between the lobes when the pipette tip is mounted on the tip mounting shaft, and wherein the circumferential shoulder has sufficient structural integrity to maintain adequate roundness of the circular cantilever sealing ring so that the annular wall seals laterally against the sealing area of the mounting shaft.
